(19) United States
(12) Patent Application Publication
(10) Pub. No.: US 2016/0335851 A1
(43) Pub. Date: Nov. 17, 2016

(54) SIDE BETS FOR BLACKJACK OR BACCARAT WITH OPTIONAL PROGRESSIVE EVENT

(71) Applicant: Mark A. LITMAN, Edina, MN (US)

(72) Inventor: Mark A. LITMAN, Edina, MN (US)

(21) Appl. No.: 14/789,995

(22) Filed: Jul. 2, 2015

Related U.S. Application Data
(60) Provisional application No. 62/183,543, filed on Jun. 23, 2015.
(60) Provisional application No. 62/172,266, filed on Jun. 8, 2015.
(60) Provisional application No. 62/160,136, filed on May 12, 2015.

(51) Int. Cl. G07F 17/32; A63F 1/00

(52) U.S. Cl. CPC G07F 17/3293; G07F 17/3244; A63F 1/00; A63F 2001/001; A63F 2001/003

(57) ABSTRACT

A method performs side bet events during a baccarat or blackjack wagering event by:
a) providing a side bet wager to be determined by playing cards during the wagering events;
b) providing two random playing cards to a dealer hand position and a player hand position;
c) determining the spread between the two random playing cards on which the side bet wager has been placed;
d) upon determining existence of a spread in excess of zero between the two random playing cards in a hand, using a third playing card such as by using a dealer position up-card, to determine if the third playing card is within or not within the spread; and
e) resolving the side bet wager against a paytable which identifies odds at least dependent on the spread determined in d).

Specially marked cards of specific suit and rank may be used to increase progressive jackpot bonuses.

### RELATED APPLICATIONS DATA

The present application claims priority from multiple U.S. Provisional Patent Applications having Ser. No. 62/183,543, filed 23 Jun. 2015; 62/172,266, filed 8 Jun. 2015; and 62/160,136, filed 12 May 2015.

### BACKGROUND OF THE INVENTION

1. Field of the Invention

The present invention relates to the field of gaming, particularly to the field of card games (both physical and electronic) and particularly to the use of side bets variations in the game of blackjack or baccarat.

2. Background of the Art

The industry has attempted to use side bet and jackpot events to attract players to games and to keep players active in games for extended periods. It has been found to be extremely difficult to develop jackpot games for use with baccarat and blackjack that have a reasonable ability to develop large jackpots (e.g., over 100,000 wagering units, such as US dollars) and to provide a significant hit frequency with less than entire jackpots being awarded. Typically, jackpots identified with blackjack and baccarat games have maximum jackpot hit frequencies in the 1:50,000 range, so that jackpots rarely exceed 50,000 units. Particularly with networked games having many tables, low total jackpots do not attract as much play as jackpots in the 100,000 unit range (that is 100,000 times the amount of the side bet wager) and 500,000 range and even in excess of a million unit range. One reason for the inability of high jackpots to be reached is that all outcomes definable from three or four cards (the initial visible cards in blackjack and baccarat) occur with frequencies below the 1:50,000 range.

U.S. Pat. No. 5,839,730 (Pike) asserts a side bet jackpot game with direct payouts against a paytable in which consecutive identical ranked playing cards (up to 6-of-a-kind) that would have a value of $1,000,000 wagering units on the side bet.

Published US Patent Application Document No. 20140309017 (LaDuca) discloses a method of playing a combined casino card game combining a standard casino card game with an optional In Between side bet that uses the same cards as played in the standard casino card game. A player makes an optional In Between side wager that the face value of at least one designated in between card falls in between or equals the face value of two designated end cards according to the “rank order” 2-3-4-5-6-7-8-9-10-J-Q-K-A. The casino card game bet and the optional In Between side bet are separate and do not affect the play of the standard casino card game. Preferred embodiments include the In Between side bet combined with casino Blackjack, Baccarat, and Texas Hold'em.

Published US Patent Application Document No. 20120280452 (Basseel) discloses a game of Blackjack may include a mid-game side-bet that the dealer will go bust. The side-bet offered may be placed against any dealer face-up card—Ace, 2, 3, 4, 5, 6, 7, 8, 9, 10, Jack, Queen, or King. The payoff may vary depending upon the dealer face-up card and paid in accordance with a pay table. The bet may be paid when the dealer hits their hand and exceeds the total of 21, therefore going bust. The bet may lose when the dealer receives a standing hand of 17, 18, 19, 20 or 21. The side-bet may be made once the dealer's face-up card has been determined. The side-bet may be asked for at one time similar to an insurance bet or as each player acts on their individual hands.

### SUMMARY OF THE INVENTION

A method and apparatus for hosting a modified game of blackjack with a player position in competition with a dealer position. The player position and the banker position receiving playing cards from one or more decks of 52 playing cards, the method comprising: performing a side bet event during a blackjack wagering event according to the present technology includes:
a) a player position providing a side bet wager to be determined by playing cards provided to the dealer hand position and/or the player hand position;
b) providing two random playing cards to a dealer hand position, and providing two random playing cards to a player hand position face up;
c) resolving the side bet wager against a paytable which identifies a spread (number of card ranks available between two cards) in a hand(s) on which the side bet wager has been placed;
d) providing a third random card as either i) a card dealt to the dealer hand or ii) using a dealer single up-card as a side bet event card on which the side bet wager has been placed; and
e) resolving the side bet wager against a paytable on a basis of whether the third random card has a rank within the spread and size of the original spread.

By using specially marked cards, a side bet progressive game can be constructed in which jackpots statistically can grow to levels above one million dollars.

### BRIEF DESCRIPTION OF THE FIGURES

FIG. 1 shows an electronic gaming table on which the gaming method may be executed.

FIG. 1A shows a schematic for an electronic system for enabling play of the gaming method described herein.

FIG. 1B shows another schematic for an electronic system for enabling play of the gaming method described herein.

FIG. 2 shows a panel used on a gaming table to show exhaustion of critical marked cards used in the progressive event.

### DETAILED DESCRIPTION OF THE INVENTION

A method and apparatus for hosting a modified game of blackjack or baccarat with a player position in competition with a dealer position. The modification includes a side bet as defined herein. The player position and the banker position receiving playing cards from one or more decks of 52 playing cards, as a standard first step in the play of blackjack or baccarat and other games, some of which may be specifically designed for use with the progressive side bet wager of the present technology. For example, a variant of three-card poker games may be used where first two card are provided to determine a spread, and then a third card is provided to act as the wedge card. The dealer may still have one card face-down when first delivered in blackjack. The players' cards are placed face up, and it is desirable if the cards are physically placed on the table with a space between them. The order and position of placement in two spots is not material, but for reasons provided herein, some separation or placement of the player position cards adjacent to each other is desirable.

A somewhat general description of this technology is a method and system of performing a side bet wagering event during a (virtual, electronic and/or physical) playing card wagering event comprising:
a) a player position providing a progressive side bet wager to be determined by playing cards provided to at least two positions distinguished by at least one of position and time on a gaming table or on a display screen;
b) providing two random playing cards to a first hand position defined as a SPREAD position, and providing one random playing card to a second hand position defined as a WEDGE card position, the SPREAD position and the WEDGE card position distinguished by at least one of physical position of delivery and time of delivery of random cards on a gaming table or as displayed on a display screen;
c) determining the spread between the two random playing cards in the SPREAD position on which the side bet wager has been placed;
d) determining whether the side bet has been lost because of a spread of zero between the two random playing cards in the SPREAD position on which the side bet wager has been placed;
e) upon determining that there is a spread in excess of zero between the two random playing cards in the SPREAD position on which the side bet wager has been placed, using the one random playing card in the WEDGE position as a third playing card to determine if the third random playing card is within or not within the spread; and
f) resolving the side bet wager against a paytable which identifies odds at least dependent on the spread determined in e) based upon the determination whether the third random playing card is within or not within the spread;
   wherein at least a portion of the side bet wager, but less than all of the side bet wager is contributed to a progressive jackpot, the amount of which progressive jackpot is stored, incremented and decremented in a processor, decrementing being based in-part upon resolution of the side bet for event outcomes including the two random playing cards in the SPREAD position and the one card in the WEDGE position, and wherein percentages of a total value amount in the progressive jackpot are awarded for defined random event outcomes when the third random physical playing card is within the spread, and the processor sends a signal to a display screen available for view at the player position indicating status of the jackpot amount. The method may be practiced wherein an original set of multiple decks of physical playing cards is used as a source for physical playing cards in b). The physical decks of playing cards may be at least two standard decks of playing cards, but preferably at least four, five, six, seven or eight standard decks of playing cards in which at least some of each of three cards in the multiple decks (especially with between six and eight decks) having sequential ranks (e.g., A-2-3; 2-3-4; A-K-Q, etc.) and same suits have a marking on them identifying them as progressive bonus jackpot cards. A percentage of the progressive jackpot is awarded to a player position that has placed the progressive side bet wager when the presence of the three cards having sequential ranks and same suits appears as a highest and lowest rank of the three sequential cards in the SPREAD position and an intermediate rank of the three sequential cards, and either one, two or three of the three sequential cards have the marking on them identifying them as progressive bonus jackpot cards. The method should be practiced where fewer than all of the three sequential cards with regard to rank and same suit used in determining percentages of progressive jackpot payouts have the special jackpot bonus markings. This, in combination with the specificity of the SPREAD position open sequence and the single WEDGE intervening card act to control available probabilities and act to maintain and enable the higher progressive jackpot amounts that are important to the invention. For example, only between 1 and 5 of each card of rank and suit within the three cards of sequential rank and same suits within the (for example, six to eight) standard decks of playing cards have the marking on them identifying them as progressive bonus jackpot cards.

The method may have, by way of non-limiting examples, the SPREAD hand determined by a player initial two-card hand in a game of blackjack and the WEDGE hand is determined by a physical dealer up-card in the game of blackjack; the SPREAD hand determined by a player initial two-card hand in a game of baccarat and the WEDGE hand is determined by a single random physical card at a banker position in the game of baccarat; the SPREAD hand determined by a player hand in a game of baccarat and the WEDGE hand is determined by a single physical card from among two physical cards at a banker position in the game of baccarat or the SPREAD hand determined by a banker initial two-card hand in a game of baccarat and the WEDGE hand is determined by a single random physical card at a player position in the game of baccarat.

An electronic version of the method and system may be described as a method of performing a side bet wagering event during a virtual playing card wagering event at an electronic wagering system comprising a housing, player input controls on the housing in communication with an accounting processor, and a video display in communication with the accounting processor, the processor being in communication with multiple individual wagering systems, the method including:
a) a player position at the electronic wagering system, the player input controls entering a progressive side bet wager that is received by the accounting processor, an outcome on the progressive side bet wager to be determined by virtual playing cards provided to at least two positions on the display system distinguished by at least one of position and time;
b) a gaming processor providing two random virtual playing cards to a first hand position defined as a SPREAD position, and providing one random virtual playing card to a second hand position defined as a WEDGE card position, the SPREAD position and the WEDGE card position distinguished by at least one of physical position of delivery and time of delivery of random cards to the video display;
c) the gaming processor determining the spread between the two random virtual playing cards in the SPREAD position on which the side bet wager has been placed;
d) the gaming determining whether the side bet has been lost because of a spread of zero between the two random playing cards in the SPREAD position on which the side bet wager has been placed;
f) upon the gaming determining that there is a spread in excess of zero between the two random virtual playing cards in the SPREAD position on which the side bet wager has been placed, using the one random virtual playing card in the WEDGE position as a third virtual playing card to determine if the third random virtual playing card is within or not within the spread; and
g) the accounting processor resolving the side bet wager against a paytable which identifies odds at least dependent on the spread determined in e) based upon the determination whether the third random virtual playing card is within or not within the spread;
   wherein at least a portion of the side bet wager, but less than all of the side bet wager is contributed to a progressive jackpot monitored by the accounting processor, the amount of which progressive jackpot is stored, incremented and decremented in the accounting processor, decrementing being based in-part upon resolution of the side bet for outcomes where percentages of a total value amount in the progressive jackpot are awarded for defined random event outcomes when the third random virtual playing card is within the spread, and the accounting processor sends a signal to the display system available for view at the player position indicating status of the jackpot amount.

After the cards are dealt in the blackjack or baccarat event, the cards are viewed and the “spread” determined. The term spread as defined as the space or number of spaces between the two cards on which the wager is placed. For example, the following cards exemplify a spread produced by those cards:

| Cards | Spread | Cards | Spread |
|---|---|---|---|
| Ace and 2 | 0 or 12 | Pairs or 10-value cards | 0 |
| Ace and 3 | 1 or 11 | Ace and 10-value card | 0 |
| Ace and 4 | 2 or 10 | 2 and 10-value card | 7 |
| Ace and 5 | 3 or 9 | 3 and 10-value card | 6 |
| Ace and 6 | 4 or 8 | 4 and 10-value card | 5 |
| Ace and 7 | 5 or 7 | 5 and 10-value card | 4 |
| Ace and 8 | 6 | 6 and 10-value card | 3 |
| Ace and 9 | 7 or 5 | 7 and 10-value card | 2 |
| Ace and 10-value | 8 or 0 (3, 2 or 1) | 8 and 10-value card | 1 |
| card | | | |

As can be seen, the spread relates to the number of card ranks that are available between the two cards on which the side bet wager has been placed. The Aces and 10-value cards may be used in various formats adjusting payout odds in the practice of the wagering event of the present technology. The variations may be used to adjust the house advantage, game volatility and the odds in the paytable. For example, the house advantage may be increased and other payout odds increased and the game simplified by all 10-value cards being considered as a single rank, as opposed to an ascending order of 10, Jack, Queen and King. In the Baccarat variation, the 10, Jack, Queen and King may maintain a zero value and be at the bottom of the count ladder, so that there is no spread between the ten-value (zero value in baccarat) cards and aces, and a spread of 1 between the zero value cards and a 2. Also, for purposes of the side bet, the Ace may be considered only a 1-value in baccarat, or only an 11-value in blackjack (except for the jackpot event as described herein), or the value (solely for the purposes of the side bet) be the value that creates the smallest spread with the other card.

If there is a progressive component in the side bet, a paytable may be structured as follows, with the unique events described in further detail later on:

A unique event pays 100% of the progressive jackpot. Lesser events may have payouts of from 5%-25 of the jackpot. Other event outcomes may have specific odds as already indicated in the table above, or even lower or higher odds to accommodate the amount contributed to the jackpot. One unique aspect of the content of the game is the identification of a specific three-card combination as the “unique event.” Any specific three-card combination may be selected, but for convenience the construction of same-suited Ace-2-3 will be considered. For example, the unique three-card combination that wins 100% of the progressive jackpot may be only the A-2-3 of a specific suit, such as spades. The jackpot may be further qualified in the winning event only when the Ace spades and 3 of spades are the first two cards and the 2 of spades is the third card. As multiple decks of playing cards are used, the probability of the maximum unique event may be further limited by designating only a limited number of the Aces of spades, 2 of spades and 3 of spades may be specially marked (e.g., the casino name) and the 100% jackpot may be paid only when at least one of the three cards in the unique event must be present for the 100% jackpot to be awarded. For example, in an 8-deck blackjack shoe, fewer than all of at least the Aces of spades (or alternatively the 2's of spades and/or 3's of spades) may be marked with the special bonus symbol. For example, in the 8-deck shoe, where there are eight Aces of spaces, only 7, only 6, only, 5, only 4, only 3, only 2 or only 1 may have the special jackpot or bonus marking. The marking may be performed on only one, only two or all three of the unique event cards may be marked, and less than all of one, two or three of cards may be used. The use of multiple ones of the marked cards and less than all of the marked card (or cards) offers the advantage of not dissuading players to avoid the side bet because an only necessary card has already been played, eliminating the possibility of any player obtaining the 100% payout on the jackpot. The use of a continuous shuffler (where all cards are returned to the shuffler after each round of play, and the returned cards are randomly inserted into the residual set of playing cards in the shuffler) partially eliminates that issue from the players. These alternatives provide significant control over the events in the jackpot events of the jackpot wagering. For example, if all three specially marked cards in the sequence are needed for 100% jackpot, the difference in probability going from 8 of each card (Ace of spades, etc.) being functional in the 100% jackpot down to only one of each of the cards in the unique event being marked can change the probability of that event occurring by more than 100-fold. The use of non-marked equivalent cards in the unique event (e.g., Aces of spades without the special mark) also adds to the availability of smaller, but significant jackpot payments. For example, if the specially marked A-2-3 of spades (or any other suit) needed for the 100% jackpot payout, combinations (of A-2-3 of spades) for example with only one of the specialty cards (e.g., a specific one card or any card) may pay 5-10% of the jackpot and combinations (A-2-3 of spades) with two marked cards may pay 10-25% of the jackpot. This shows the flexibility of the wagering event.

Certain jurisdictions may have regulations that require that the largest available jackpot winning outcome must be available for that wager to be allowed. For example, in the event that a uniquely marked Ace, uniquely marked 2 and uniquely marked 3 are required for the final 100% jackpot winning event, in theory, once all of the specially marked cards of a single value are exhausted from tan original set (shoe) of playing cards, the side bet wager might no longer meet regulations. This can be addressed in numerous manners. As noted elsewhere, a continuous shuffler may be used so that all recently used cards are immediately returned to the set of playing cards. Alternatively, with card reading delivery shoes and card-reading shufflers, the processor can be configured to determine when all of at least one essential specially marked card (from the set of three or set of at least two specific cards) has been exhausted from the set of available random playing cards. For example, if a specially marked Ace of spades is needed for the 100% jackpot, and there were four marked Aces of spades out of a six-deck show, once all four of the marked Aces of spades have been used, the shoe/shuffler is shut down and a new set of playing cards provided. An alert notice can be provided by an alphanumeric display on the delivery shoe or shuffler, or a special alert bulb or alarm can be provided. The card set would be replaced immediately after the last available necessary specialty card was provided. Where at least two cards with jackpot specialty marks are needed for the Jackpot (e.g., at least two of the Ace-2-3 same suited cards must have the specialty marks), all three cards may be tacked by the card-reading shoe or shuffler, and when two of the three ranks of cards have been exhausted, then the notice, alert or alarm would be provided.

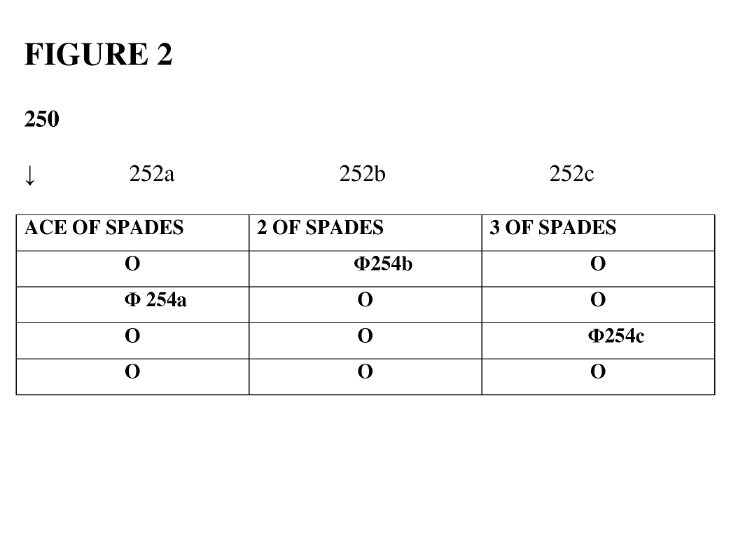

FIG. 2 shows a panel 250 with three distinct columns 252a, 252b and 252c indicating, respectively, remaining numbers of specially marked Aces of Spades, 2 of Spades and 3 of Spades. The panel may also be provided as a marked area controlled by a live dealer, who moves a marker or lamer from positions within the panel 250 to indicate exhaustion of critical cards. As shown in FIG. 2, there are spaces in the panel 250 indicating availability of four (4) of each of the specially marked cards critical to winning outcomes that award percentages (e.g., 5%, 10%, 15%, 20%, 25% or 100%) of the total jackpot accumulated. As shown in the FIG. 2, spaces have markers that indicate remaining numbers of critical cards of specific rank by a symbol e.g., Φ254a indicating there are three of four original specially marked Aces of Spades cards. The panel may have only indications of three critical cards and marked appropriately. In the panels, the O's are neutral marks or spaces where lammers or markers may be placed. In FIG. 2, the position of the markers Φ254b indicates four available 2 of Spades and Φ254c indicates two available 3 of Spades. In this way, legal compliance may be observed and information provided to players. It is not necessary to make such indications on electronic gaming machines where new sets of playing cards (e.g., in increasing order of preference, a single deck, two decks, four decks, sic decks, eight decks, etc.) are provided at the beginning of each round of play. Numbers of each of the specialty cards may be varied to further control the odds in the electronic systems. Numbers of specially marked cards may even be varied according to the time of day to weight probability of a win so that larger numbers of people may be available to observe a major win. For example, the normal level of three or four specially marked cards of each critical card (generally exemplified as the Ace of Spades, 2 of Spades and 3 of Spades, although other combinations may be used, especially where the dealer position up card is used as the random third card) may be four cards in eight decks, and the reduced (but still legally allowable) frequency at different times of play may be three of each (or fewer than all, such as only 2's of Spades) specially marked card or even two of each (or less than all, such as only Aces of Spades and 3 of Spades) to reduce the probability of each major percentage win from the progressive jackpot.

As has and will be particularly indicated, many variations within the disclosure of this technology are available. For purposes of examples, A-2-3 or A-K-Q of same suited and specially marked cards have been particularly indicated. These are exemplary but arbitrary specific ranks as the use of spades and hearts in the discussion are arbitrary suits for the unique percentage jackpot awards. As within different cultures, different numbers can have different connotations, such as 4 and 8 in certain Pacific Rim cultures, the unique card combinations and outcomes may include these emotive cards in the jackpot events. For example, the spread may be determined by ranks of 3 and 5 (so that the 4-value card is the wedge card), 7 and 9 rank cards (so that the 8-value card is the wedge card) or 6 and 8 rank cards so that a 7-rank card is the wedge card. Any designated card, even cards without a single spread range may be used. For example, if the jackpot winning event is arbitrarily selected as 2-4-6, or Ace-3-5, or 2-4-8, or 4-8-King, those cards may be specially marked in a selected suit or even combination of suits, and the appearance of the outermost spread defining cards, 2-6, Ace-5, 2-8 and 4-King, respectively, makes the jackpot percentage award available. The only drawback with some of these variations is potential confusion if a filling card other than the bonus card is provided, or if different suits are used in the percentage jackpot awards, the determination of the final outcome is more confusing and time consuming. The use of a single suited event and a spread of any combination of cards with a single rank between them is the simplest and least confusing event.

In baccarat side bet events, similar considerations may be used. In a two-card spread baccarat game, for example, the spread hand (in either the player hand position or the banker hand position, by design or by allowance of either position with the side bet) may be the Ace and 4-rank of the same identified suit, and the winning wedge hand will be both the 2-rank and 3-rank cards of the same suit and preferably also the special markings on at least one, two, three or four of those cards. The order of the rankings and distribution of the rankings should be maintained as a split event to keep the feel of the Acey-Deucy type game and for ease of resolution and control of the probabilities. For example, the presence of A-4 in one hand and 2-3 in the other hand is much less likely than the appearance of all four of A-2-3-4 in both hands without consideration of distribution. That format could be used, but that would cause the jackpot event to have lower totals because of more rapid payouts. The payouts could also be made more frequent or otherwise adjusted by having a 5% payout for one specially marked card, 10% for two specially marked cards, 20% for three specially marked cards and 100% for four specially marked critical cards. To control the frequency of payouts and jackpot rate of growth in baccarat, a higher frequency of specially marked cards may be needed for 100% jackpots to be paid out. For example, in the blackjack variant of the side bet wedge event, it is believed that three or four specially marked cards provides a desired balance between frequency of payouts of percentages of the jackpot and rate of growth and size of the jackpot. In the baccarat variant, because two filling same-suited, specially marked cards must form the wedge event (as opposed to one filling card) the frequency of the event is reduced. It is therefore felt that four, five or even six specially marked ones of the same-suited critical cards is more desirable. This will increase the frequency of the smaller jackpot payouts, and their size may be accordingly lowered to keep the rate of growth of the 100% jackpot amount higher. For example, the one specially marked card successful wedge event may pay 2-4%, the two specially marked card successful event may pay 3-7%, the three specially marked card successful wedge event may pay from 7-15% and the four specially marked card successful wedge event (e.g., 1-4 in one hand and 2-3 in the other hand) would pay 100%. Again, the selection of rank and suite can be varied. The winning combinations can be hand distributions of 2-5 and 3-4, 3-6 and 4-5, 10-K and J-Q, J-Ace and K-Q and the like. Again, it is simplest if the spread is kept at two ranks and the edge must fill exactly the two same-suited cards within those rankings, with at least one specially marked card present.

The paytable for the four-card baccarat wedge event must be significantly different from the blackjack paytable. Spreads of one may also be “dead hands” in the baccarat game as only a specific rank pair can be between both cards. This could also be a high payout award. For example, where the spread hand is 3-5, the wedge hand of 4-4 might pay 25:1. It is desirable to require that both wedge hand cards fall within the split for simplicity, although there might be small award odds for single cards. Requiring both wedge hand cards to fill the spread will create much higher volatility, with much higher odds available. It is also likely that each of 10, Jack, Queen and King will be) value cards and of equal rank in play, as this comports with play in baccarat. An exemplary range of payouts for the wedge side bet be:

| Spread | Two Card Wedge Fill |
|---|---|
| 1 | 20:1 to 50:1 |
| 2 | 15:1 to 25:1 |
| 3 | 10:1 to 20:1 |
| 4 | 5:1 to 12:1 |
| 5 | 3:1 to 5:1 |
| 6 | 2:1 to 4:1 |
| 7-8 | 1:1 |

The odds may be varied outside these ranges. Joker(s) cards may also be used as null special cards with different payouts or payout multipliers. Payouts in excess of 10:1, 15:1 or 20:1 may or may not be decremented from the jackpot.

In electronic gaming, video gaming, on-line gaming and the like, many of the above problems associated with depletion of critical specially marked cards become trivial. Multiple decks may be used with a single specialty marked card for one, two or three of the unique event cards, and new virtual sets of cards may be provided at the beginning of each round of play.

The method generally may have steps of: performing a side bet event during a blackjack or baccarat wagering event according to the present technology (the side bet amount may be any minimum amount, such as $1.00 or may be in amounts up to the table minimum or maximum), and the steps includes:
a) a player position providing a side bet wager to be determined by playing cards provided to the dealer hand (banker hand position in baccarat) position and/or the player hand position; (the wager may be placed on the player hand, a dealer hand or even a dummy hand as later described. As explained, there are advantages to each option.) The dealer position up-card may be best used as the card indicating whether the spread in the player hand is filled. That is because the play of the underlying game is not affected, and the side bet game is immediately resolved. Tension is still provided by waiting to see the dealer up card. The use of the player hand in the side bet wager assures the likelihood of only a single winner. The use of the dealer hand in the side bet wager would assure that all players entering the jackpot event at a single table would share the jackpot if won. If a dummy hand is used at the end of game play (receiving a required third card for the split or fill wager side bet event), two cards are dealt to the dummy position and a third card dealt to determine the event outcome, players will not feel that any actions done by intermediate players are affecting their own chances of game events. This method would also assure that all players entering the jackpot event at a single table would share the jackpot if won.
b) providing two random playing cards to a dealer hand position, and providing two random playing cards to a player hand position face up; (Placement of the cards can have significance for security issues, so that a third card is not intentionally or accidentally confused with one of the original cards dealt to the position on which the side bet wager has been placed. The cards may be placed adjacent each other (with no space between them, and the third card placed overlapping a lower portion of both playing cards. The cards may also be placed on two spaces specifically marked or generally positioned for receiving the first two cards, with the space between them marked or sufficiently wide that placement of the third card should be clearly distinguished from the other cards. The dealer position may also have the first two cards (even with one face-down) similarly positioned when the third card (if any) is delivered to the dealer position.
c) providing a third random card to the hand(s) on which the side bet wager has been placed; and
d) resolving the side bet wager against a paytable on a basis of whether the third random card has a rank within the spread and size of the original spread.

A non-limiting example of a paytable for the side bet wager (without a progressive event) may be as follows:

| SPREAD | PAYOUT ODDS |
|---|---|
| 1 | 8:1 to 12:1 or 10:1 to 15:1 |
| 2 | 5:1 to 6:1 6:1 to 8:1 |
| 3 | 3:1 to 4:1 4:1-6:1 |
| 4 | 1:1 to 2:1 2:1 to 4:1 |
| 5 | 1:1 to 2:1 2:1 to 3:1 |
| 6 | 1:1 to 2:1 2:1 |
| 7 or more | 1:1 1:1 |

There may also be a side bet progressive component, with a portion of the side bet wager being automatically contributed to a progressive jackpot. Anywhere from 10% to 90% of all side bet wagers may be used to contribute

General Considerations for Side Bet for Blackjack with Progressive Component

Side Bet must be made before cards are dealt in normal blackjack fashion.

Side Bet may be in any amount up to Ante or maximum values.

Side bet is on an Acey-Deucey type event against a paytable.

If any player's third card is a value between the values of the first two cards, it is a winning outcome. The paytable may be based on size of range between first two cards without busting. (Depending on math, a bust of 22 may be allowed for the side bet if the player must take a third card in a circumstance where a hit would ordinarily not be taken.) Specific ranges of SPREAD may be excluded from payments on odds, such as spreads of 6, 7 and/or 8. The Ace-2 cards may be automatically treated the same for both baccarat (where the cards are always adjacent points with a SPREAD of zero) and blackjack during play could be one (1) and adjacent the 2 or eleven (11), creating a spread of eleven or eight (as all ten-value cards are equal).

The preferred method of play, however, is using the dealer up-card as the third random card indicating whether or not the spread in the player hand is filled and the side bet won, at odds or percentages of the jackpot.

With a 2 and 9 or ten value card as first two cards (a six or seven point spread), any value between 3 and 9 pays 1:1.

With any four or five point spread, side bet pays at least 2:1.

With any three point spread, side bet pays at least 4:1.

With any two point spread, side bet pays at least 6:1.

With a one point spread (e.g., 6 and 8), the side bet pays at least 10:1.

Jackpots may be paid when first two cards are any two same-suited, 2 or 3. That will pay 10% of the progressive jackpot, unless the first two cards are the Ace and Three of Spades and the third card is the 2 of Spades, especially with one, two or three of the Ace, 2 and 3 having special markings thereon. (Described in greater detail above)

There are other controls over game play that can impact the house advantage and play. For example, the player may lose the side bet with a natural hard 17 (as no card can be between the 10-value card and the 7 without busting) and pushes or loses with a natural 18, 19 or 20 and loses, pushes or wins 1:1 with a blackjack.

It is to be noted that the odds for the various spreads are merely exemplary. In fact, odds at variance with apparent normal odds may be used. For example, the 10:1 odds appear to be typical odds for an event with a 1/13 probability. However, as the condition for the wager may not occur (the initial hand may be “dead” by being a pair, consecutive cards, face cards, etc. so the split side bet event may not occur), so that actual offered odds may be higher than even the statistical probabilities. For example, for a spread of one, odds of 13:1, 14:1; 15:1 or even higher may be offered. For a spread of two (with statistical odds of 1/6.5), odds of 6:1, 7:1 or even 8:1 or higher may be offered. In this manner, the casino may offer payout odds that are statistically higher than the probability of the spread being filled by a third card.

As can be seen, the player always also loses the underlying wager in blackjack when the player MUST take a hit to provide the third random card, with a natural 16 on the first two cards, as no card can be between 6 and 10 without busting. A same value card as either of the original cards is a loss. It is also possible to allow players to take a hit “off the books” for the blackjack event or baccarat event, such that the player may exercise a step in the side bet, without altering normal play in the blackjack game. This is the advantage of using electronic gaming or the dealer up card as the third playing card.

A new gaming technology, referred to a Mix and Match gaming events in poker, blackjack and baccarat. These gaming events are in part disclosed in U.S. patent application Ser. Nos. 14/620,158 and 14/677,974 filed 3 Apr. 2015, both of these references being incorporated by reference in their entirety to described the underlying wagering Mix and Match wagering event.

The blackjack variant may be generally described as a A method for conducting a blackjack card game using:
a) accepting an ante wager on a round of blackjack at a player position;
b) providing three random playing cards to a display system at a player position and three random playing cards to a dealer position,
c) the blackjack card game being played between the dealer position and the player position according to the predetermined rules of blackjack card games utilizing playing cards where all face cards count ten, aces count one or eleven, and all other cards count their face value, in which each player position makes the ante wager; d) the player position discards one card to form an initial player position two-card blackjack hand;
e) the dealer position discards one card to form an initial dealer position two-card blackjack hand;
f) the player position receives random cards to complete a blackjack hand at the player position according to player position direction to stand or hit;
g) the dealer position receiving random cards to complete a blackjack hand at the dealer position after f) is completed according to dealer position direction to stand or hit; and
h) the dealer resolving all wagers at the player position hand by standard blackjack rules of resolution.

An alternative method of play is described as a method for conducting a blackjack card game using physical playing cards in which:
a) a dealer accepts an ante wager on a round of blackjack at a player position;
b) the dealer sending three random physical playing cards to a display area at a player position and three random physical playing cards to a dealer position display area, where at most one of the dealer position three random cards is displayed,
c) the blackjack card game being played between the dealer position and the player position according to the predetermined rules of blackjack card games utilizing playing cards where all face cards count ten, aces count one or eleven, and all other cards count their face value, in which each player position makes the ante wager;
d) the player position discards one card from the player position three playing cards to form an initial player position two-card blackjack hand;
e) the dealer position discards one card from the dealer position three playing cards to form an initial dealer position two-card blackjack hand;

A method completes a wagering event using playing card symbols to determine a random event outcome. The symbols may be provided by physical playing cards or by virtual playing cards provided by a processor. The process proceeds by:
a) recognizing a wager (either a physical wager with a chip, token or currency, or an electronic wager as from a player input terminal received by a processor) from a player position on a player hand win, a banker hand win or a player hand-banker hand tie event according to final digit point count in the player hand and the banker hand;
b) providing exactly three random standard playing cards face-up to a player position;
c) providing exactly three random standard playing cards face-up to a banker position;
d) discarding exactly one random standard playing cards from each of the banker hand and the player hand to form a two-card baccarat player hand and a two-card banker hand;
e) completing the two-card baccarat player hand and the two-card banker hand according to standard requirements of staying and hitting on point counts in the two-card baccarat player hand and two-card banker hand to form a final player hand and a final banker hand;
f) summing up point count in each of the final player hand and the final banker hand separately, and valuing the player hand and the banker hand according to a last digit only in summed up point count;
g) determining outcomes in a comparison between the player hand and the banker hand as follows:
   i) a higher summed up point count in the player hand as compared to the summed up point count in the banker hand is a winning outcome for the player hand;
   ii) a higher summed up point count in the banker hand as compared to the summed up point count in the player hand is a winning outcome for the banker hand;
   iii) an identical summed up point count in the player hand as compared to the summed up point count in the banker hand is a tie outcome for both the player hand and the banker hand;
      resolving wagers in a) according to determined outcomes in i) and ii) and iii) at payout odds against wagers in a) according to outcomes i), ii) or iii) determining the outcome of the wagers.

Player (either with tokens, chips, currency or the like in a table game; or with credit in an electronic gaming machine version) may choose to bet on the Player hand, the Banker hand or a Tie event.

As in traditional Baccarat and mini baccarat, the dealer (or electronic computer acting as a virtual dealer) will deal one hand for the player and one hand for the Banker using the following drawing rules after a starting two-card hand is formed from the original three-cards at each of the player hand position and the banker hand position:

These cards are scored using the traditional Baccarat scoring method, with the numerical value of all cards in a hand summed (with 10, Jack, Queen and King being zero value) and only the last digit (the unitary value digit) being considered.

### Ties.

If the final Player and Banker point total is equal, a tie wager will pay between 7:1 and 9:1, usually 8-1.

A method of playing a simplified wagering game using playing card symbols to determine a random event outcome may include:
a) recognizing a wager on a player hand win, a banker hand win or a player hand-banker hand tie event according to final digit point count in the player hand and the banker hand;
b) providing exactly three initial random standard playing cards face-up to a player position;
c) providing exactly three initial random standard playing card face-up to a banker position;
d) discarding exactly one standard playing card from each of the three standard playing cards in the banker hand and the dealer hand to form a starting two-card player hand and a starting two-card banker hand;
e) summing up point count in each of the starting player hand and the starting banker hand separately standing or hitting according to standard baccarat rules to form a final player hand and a final banker hand;
f) determining outcomes in a comparison between the player hand and the banker hand as follows:
   i) a higher summed up point count in the final player hand as compared to the summed up point count in the final banker hand is a winning outcome for the final player hand;
   ii) a higher summed up point count in the final banker hand (whether from a three-card only hand or a two-card hand) as compared to the summed up point count in the final player hand is a winning outcome for the final banker hand;
   iii) an identical summed up point count in the final player hand as compared to the summed up point count in the final banker hand is a tie outcome for both the player hand and the banker hand;
g) resolving all wagers with payout odds in a) according to outcomes i), ii) or iii) determining the outcome of the wagers.

The method of resolving each of wagers determined by i) and ii) are resolved with 1:1 odds when the player hand has a higher count than the banker hand, with 1:1 odds when the final banker hand count is higher than the final player hand count (typically with a commission of 5, 10 or 15% taken from the 1:1 payoff on a banker hand winning wager). The wager determined by iii) is resolved with odds of at least 7:1, up to 9:1 and usually at 8:1.

The method is best performed where discards are required so that a highest count of 6, 7, 8 or 9 is formed in the two starting hand cards if possible and a lowest count among 0, 1, 2, 3, 4 and 5 is formed in the two starting hand cards. Variations in the best performance requirements may be that a highest count of 5, 6, 7, 8 or 9 is formed in the two starting hand cards if possible and a lowest count among 0, 1, 2, 3 and 4 is formed in the two starting hand cards.

The method is preferably performed where playing cards are provided by provision of random physical playing cards provided from a randomized source of physical playing cards, and the physical playing cards are placed one-at-a-time from the source of physical playing cards to respective player hand position and banker hand position.

### Mix and Match Baccarat.

In Mix and Match Baccarat, both the player and banker hands are dealt three initial cards each. Both the player hand and the dealer hand select the two cards that make the most favorable point total and discard the remaining third card.

The following procedures should be used to determine which two cards are held:

### Procedure 1:

If it is possible to create a two-card total of 6, 7, 8 or 9 points, the player and banker hand will be set with that point total.

Example: The player hand is dealt a 10, 7, and 6. The player hand will keep the 10 and 7 for a total point value of 7 and discard the 6.

The banker hand is dealt a 2, 4 and 4. The banker hand will keep the 4 and 4 to create a total point value of 8 and discard the 2.

### Procedure 2:

If for either the player hand or the banker hand, two cards cannot be selected to produce a combined point total of at least 6, the hand will be set making the lowest possible point total.

Example: The player hand is dealt and 2, 3 and 8. The player hand will be set with the 2 and the 8 to form a point total of 0. This is the lowest possible point total when the hand cannot produce a point count of at least 6, 7, 8 or 9 with any combination of two cards.

The banker hand is dealt an ace, 10, and 3. The banker hand will be set with the ace and 10 to form a point total of 1. After the player and banker hand are set, normal baccarat drawing rules and payout rules will apply.

### Optional 6-Tie Variation.

In the event of a 6-6 tie, the banker has the option to take the tie or double their wager, indicating that they want to draw an additional card to try to beat the tie. If the drawn card produces a losing total, both wagers (base wager and double down wager) are lost. If the drawn card has a point value of zero, the wager is pushed. If the drawn card produces a 7, 8 or 9, both the initial banker wager and the double down wager pay even money. The player wager will push no matter the banker outcome.

The method may have the three player position cards are physical playing cards dealt from a randomized set of playing cards, and the three dealer position cards are physical playing cards dealt from the randomized set of playing cards.

The underlying execution of the method may include events wherein a player makes a first wager and is dealt three cards either face up or face down. The dealer is dealt two cards face down and one card face up. The player acts first. The player will examine his three cards and discard one card. The remaining two card-hand point total will be the player's starting hand in a basically traditional blackjack event. After player chooses which card to discard, the dealer will muck that card. The player will then play his hand under normal 21 rules (choosing to hit, stand, double down, or split).

After all individual players have acted, the dealer will reveal all three cards. The dealer will chose to discard one card and keep the other two in play. The dealer will use the following procedures to determine which card to discard called the Hi/Lo method.

If the dealer can make a 17, 18, 19, 20, or 21 with two of the three cards present, the dealer will make the highest of those hands and discard the remaining card (obviously in a situation where the dealer's three cards were 10, 10, 9, the dealer would discard the 9 to make a two-card hand of 20).

If the dealer cannot make a 17, 18, 19, 20, or 21, the dealer will set the hand with the following priorities:

If the dealer can make a 2-card point total of 11 or 10, the dealer will prioritize that setting.

If the dealer cannot make a 2-card 11 or 10 and has an ace, the dealer will prioritize making the lowest soft point total (such as a soft 12).

If the dealer cannot make a 2-card 11 or 10 and does not have an ace, the dealer will choose the two cards that produce the lowest point total. For example, if the dealer has 10, 6, and 2, the dealer will select the 6 and 2 to make an 8 point total.

After the dealer has selected the card to discard, the dealer will follow standard drawing rules until he has made a 17, 18, 19, 20 or 21 point total or has “busted” with a total greater than 21.

The method may be performed on a gaming table and the side bet wager are provided through an electronic wagering input device on the gaming table, and the input device communicates location of a player position at which a side bet wager has been placed and an amount of the side bet wager to a processor. The processor may transfer a portion of the side bet wager into a progressive jackpot account monitored by the processor and the processor causes a display to visually indicate an available balance in the jackpot. The method may designate a highest rank formed with only the four cards from a combination of the two random playing cards in the banker position hand and the two random playing cards in the player position hand is a pair or three-of-a-kind no winning outcome is present on the paytable. The method may be executed wherein when a highest rank formed with only the four cards from a combination of the two random playing cards in the banker position hand and the two random playing cards in the player position hand is a pair or three-of-a-kind no winning outcome is present on the paytable, or when a highest rank formed with only the four cards from a combination of the two random playing cards in the banker position hand and the two random playing cards in the player position hand is a pair or three-of-a-kind no winning outcome is present on the paytable, or when a highest rank formed with only the four cards from a combination of the two random playing cards in the banker position hand and the two random playing cards in the player position hand is a straight, no winning outcome is present on the paytable, or when a highest rank formed with only the four cards from a combination of the two random playing cards in the banker position hand and the two random playing cards in the player position hand is a flush, no winning outcome is present on the paytable. Various low frequency combinations of playing cards may be used as the four-card poker ranks to determine maximum payouts from the progressive jackpot. For example, a maximum payout from the progressive may be selected from the group consisting of four-of-a-kind and a same-suited A-K-Q-J. The method may be formed with other defined hand conditions to increase or reduce the frequency of the ranks that provide the maximum payout from the progressive jackpot. For example, the highest payout rank may be selected from the group consisting of a same-suited four-of-a-kind and a same-suited A-K-Q-J wherein the A-K are in a single one of the player position hand or the banker position hand.

As further described and enabled herein, the method may be performed wherein multiple players have placed side bet wagers against the paytable, at least some of the players being at player positions at a gaming table and at least some of the players being in electronic communication with the gaming table through the processor. A game performance issue occurs with this type of cross-technology and large number of players situations. As all side bet wagers rely on a single set of four cards (the first two banker position cards and the first two player position cards), the jackpot can be divided into so many small parts that the jackpot event becomes less attractive. For example, players would be attracted to a $1.00 side bet with a potential $50,000 or higher payout. However, if there are 100 players making side bets, an equal division of the jackpot would be only $500.00. Knowledgeable players would not be attracted to that side bet event because of the low return as compared to the probability of occurrence. A less desirable format is therefore where upon occurrence of a maximum payout event, the maximum payout is divided among all players having made the side bet. Numerous protocols can be implemented, especially with electronic wagering and a processor in the system. One simple adjustment is to limit the total number of players that can enter the side bet event (for example, in a first-come, first serve mode), or to apportion shares in the maximum payout based on amounts wagered on the side bet event (e.g., a $5.00 wager receiving five times the portion that a $1.00 wager would receive.

There are additional protocols wherein the processor is configured to execute a protocol that divides the maximum payout unequally among all players having made the side bet. The method could be configured such that the processor receives and stores electronic data from electronic wagering input devices comprising at least some data selected from the group consisting of a) length of time a player position has been wagering at the gaming table, b) number of consecutive hands that have been wagered on from a player position, c) average value of wagers made from a player position, d) maximum wager placed from one player position as compared to all player positions making side bet wagers, e) a random selection among players, and f) identified subsets of players based upon betting histories.

In baccarat, versus blackjack, similar procedures may be used. The banker hand or the player hand may be indicated (by wager or fixed rule, preferably as the spread defining hand. The two cards in that spread defining hand are dealt and the first card in the other hand is dealt face-up. The side bet (otherwise identical to the blackjack side bet) can be resolved at that point, before the second other hand card is dealt. An alternative variant, with lower hit frequency but accordingly higher payout odds may be used for baccarat. The two hands are referred to herein as the spread hand (in which the spread is determined) and the wedge hand, in which filling of the spread is determined. Two cards are dealt to each hand, and the split wager is resolved by at least one of the wedge hand cards being within the spread and the other of the cards being within the spread or equaling the rank of the (preferably lower rank) other card. The jackpot bonus may be won by the spread hand being a spread of one and the two spread hand cards being a predefined specific rank and suit combination (e.g., A of hearts and Queen of Hearts again, or A of Diamonds and 3 of Diamonds, again with a distribution/control of numbers of these cards that are specially marked. Special marking may be eliminated by requiring that both of the wedge hand cards fill the single rank spread with both wedge hand cards being the suited cards. For example, if the jackpot combination is A-K-Q of Hearts, the spread hand must have the A-Q of hearts, and both cards in the wedge hand must be the King of Hearts. A null card of a joker may also be present so that for the 100% jackpot to be won, the exact wedge card and the joker may be present. Smaller percentages can be won by the wedge hand having the exact filling rank and suit, and the other card being the same rank and the same color, but different suit, or just the same rank. In baccarat, specific order or collective content of specific cards may be used for the jackpot event. For example, the banker or player hand may be required to have the specific suited Ace and 4, the respective player or dealer hand must have the specific suited 2 and 3, and the two hit cards must be compatible with the requirements of the third card rule, the player's third card must be a same suited Ace or 2, and the banker hit must be the same suited 3. This may be done with or without specially marked Aces, 2's and 3's of the desired suit winning the jackpot level of the side bet. A paytable for other events, such as three-card ties, three zero-value cards in both hands, three zero-value same suited cards in individual hands or both hands, etc. These paying events are needed to keep the player engaged in the side bet game.

The wagering event may be practiced with at least one, two, four, six or preferably eight decks as the original set of physical playing cards and two physical playing cards are provided to each of the banker hand position and the player hand position to form a first residual set of physical playing cards having 412 physical playing cards and then any additional physical playing card provided to the player position will be provided from the first residual set of physical playing cards to form a second residual set of physical playing cards having 411 physical playing cards. Any additional physical playing card dealt to the banker position is provided from the second residual set of physical playing cards. As is typical with baccarat and blackjack gaming events, especially high-stake games, the original randomized set of playing cards is not played to exhaustion of the cards where card-counters could identify advantages or disadvantages in events, especially side bet events.

The method may use a set of eight decks of virtual playing cards stored in memory in a processor which is configured to display virtual playing cards on a video display, and two virtual playing cards are provided to each of the banker hand position and the player hand position to form a first residual set of virtual playing cards in the memory having 412 physical playing cards and then any additional virtual playing card provided to the player position will be provided from the first residual set of virtual playing cards to form a second residual set of virtual playing cards having 411 virtual playing cards in memory. Any additional virtual playing card dealt to the banker position is provided from the second residual set of virtual playing cards. Gaming apparatus may comprise a processor, player input controls and a video display, wherein the processor is configured to execute the electronic virtual card method described herein.

Gaming apparatus comprising a gaming table having a randomized physical set of playing cards comprising 416 playing cards in a dealer shoe with only a back of one card displayed to live players, the gaming table configured to allow play of the physical playing card method described herein. Playing card shufflers or randomizers may be used in accordance with this method as further described herein.

### Computer-Based Implementations

Methods of the present invention may be implemented in computer hardware, software, or computer hardware and software. A most common form of computer implementation is a stand-alone, single player electronic gaming machine with electronic player controls and one or more video output screens.

In computer-based embodiments, the gaming device preferably includes at least one processor, such as a microprocessor, a microcontroller-based platform, a suitable integrated circuit or one or more application-specific integrated circuits (ASIC's) or Field Programmable Gated Arrays (FPGA's). The processor is in communication with or operable to access or to exchange signals with at least one data storage or memory device, and/or a player monitor or monitors. In one embodiment, the processor and the memory device reside within the cabinet of a gaming device. Multiple gaming devices are typically connected to a casino information network.

The memory device stores program code and instructions, executable by the processor, to control the gaming device. The memory device also stores other data such as image data, event data, player input data, random or pseudo-random number generators, pay-table data or information, House Ways distributions and applicable game rules that relate to the play of the gaming device. In one embodiment, the memory device includes random access memory (RAM): which can include non-volatile RAM (NVRAM): magnetic RAM (MRAM), ferroelectric RAM (FeRAM), and other forms as commonly understood in the gaming industry. In one embodiment, the memory device includes read only memory (ROM). In one embodiment, the memory device includes flash memory and/or EEPROM (electrically erasable programmable read only memory). Any other suitable magnetic, optical, and/or semiconductor memory may operate in conjunction with the gaming device disclosed herein.

In one embodiment, part or all of the program code and/or operating data described above can be stored in a detachable or removable memory device, including, but not limited to, a suitable cartridge, disk, CD ROM, DVD, or USB memory device.

In other embodiments, part or all of the program code and/or operating data described above can be downloaded to the memory device through a suitable network. In one embodiment, an operator or a player can use such a removable memory device in a desktop computer, a laptop computer, a personal digital assistant (PDA), a portable computing device, or another computerized platform to implement the present disclosure. In one embodiment, the gaming device or gaming machine disclosed herein is operable over a wireless network, for example part of a wireless gaming system. The gaming machine may be a hand-held device, a mobile device, or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission. It should be appreciated that the processor and memory device may be collectively referred to herein as a “processor” or “computer” or “controller” or “game controller.”

In one embodiment, as discussed in more detail below, the gaming device randomly generates awards and/or other game outcomes based on probability data. In one such embodiment, this random determination is provided through utilization of a random number generator (RNG), such as a true random number generator, a pseudo random number generator, or other suitable randomization process. In one embodiment, each award or other game outcome is associated with a probability and the gaming device generates the award or other game outcome to be provided to the player based on the associated probabilities. In this embodiment, since the gaming device generates outcomes randomly or based upon one or more probability calculations, there is no certainty that the gaming device will ever provide the player with any specific award or other game outcome. It is also possible for templates or weighted templates of sets of tiles or paylines as disclosed in U.S. Pat. Nos. 6,159,096 and 6,117,009 (Yoseloff, which are incorporated by reference in their entirety) which disclose a method of configuring a video output gaming device to randomly generate game outcomes. The method includes the steps of selecting a set of game symbols, assigning a probability of occurrence to each symbol, selecting a plurality of outcome templates, each template comprising X variables, selecting a probability of occurrence for each outcome template, assigning a subset of symbols from the set of game symbols to each template for filling the positions, defining payouts for selected outcomes, and configuring a video output gaming device, which randomly selects a template, randomly selects a symbol for each variable in the template from the subset of game symbols assigned to the selected template, randomly fills at least a portion of the positions in the template and displays the outcome on a video output display. A video output gaming device programmed to randomly select a template, randomly select symbols to define the variables and randomly display the selected symbols is also disclosed.

In one embodiment, described in more detail below as a “chipless gaming platform”, the gaming device includes one or more display devices that are mounted into a gaming table surface and are controlled by the processor in addition to or separately from the individual player monitors. The display devices are preferably connected to or mounted into the table structure. This may include a central display device which displays a primary game, dealer images, jackpot information, or information that is not specifically related to the game, such as sports information or winning events at other tables. This display device may also display any suitable secondary game associated with the primary game as well as information relating to the primary or secondary game (e.g., side bets, bonuses, jackpots and the like).

An alternative embodiment may include a central horizontal game display device and a vertically oriented virtual dealer display device as in Shuffle Master, Inc.'s Table Master™ gaming system. The central display device may display the primary game, any suitable secondary game associated or not associated with the primary game and/or information relating to the primary or secondary game. These display devices may also serve as digital glass operable to advertise games or other aspects of the gaming establishment. The gaming device includes a credit display 20 which displays a player's current number of credits, cash, account balance, or the equivalent. In one embodiment, the gaming device includes a bet display displays a player's amount wagered. In one embodiment, as described in more detail below, the gaming device includes a player tracking display which displays information regarding a player's play tracking status.

In yet another embodiment, at least one display device may be a mobile display device, such as a PDA or tablet PC that enables play of at least a portion of the primary or secondary game at a location remote from the gaming device. The display devices may include, without limitation, a monitor, a television display, a plasma display, a liquid crystal display (LCD) a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism.

In one embodiment, as described in more detail below, the display device includes a touch-screen with an associated touch-screen controller. The display devices may be of any suitable size and configuration, such as a square, a rectangle or an elongated rectangle. The display devices of the gaming device are configured to display at least one and preferably a plurality of game or other suitable images, symbols and indicia such as any visual representation or exhibition of the movement of objects such as mechanical, virtual, or video reels and wheels, dynamic lighting, video images, images of people, characters, places, things, faces of cards, images of dealers and the like.

Other forms of the invention are in the form of game software that is implemented in a variety of formats, such as internet gaming, PC practice play, hand-held game devices, wireless gaming devices and the like.

### Chipless Gaming Table Implementation

One enabling system useful in the practice of the present invention is the use of playing cards with Chinese domino symbols which can be distributed for use with a system marketed under the name i-TABLE™ by Shuffle Master, Inc. of Las Vegas, Nev. That system includes: a) a physical gaming table; b) player monitors at each player position; c) a playing card reading and delivery system (e.g., commercially available shufflers and playing card delivery shoes with reading capability as sold under the Trade names of One2Six™ shuffler, Ace™ shuffler, I-DEAL™ shuffler, I-SHOE™ delivery shoe, etc.); d) a processor receiving information (numbers of cards, rank of cards, suits of cards, etc.) from the card reading and delivery systems; e) communication connectivity (hardwired or wireless) between necessary combinations of the card reading/delivery systems and the processor, the processor and the individual player monitors, and/or the card reading/delivery systems and the video monitors; and f) software in the processor that defines predetermined advantage for distributions of playing cards into multiple hands, game rules, hand history, and the like.

With regard to software f), it is understood in the practice of the present technology that this is not complex software that reads individual player hand cards and determines advantageous card distributions for a first time by extensive calculations. Rather, the entire range of possibilities of hands (e.g., all possible five card sets dealt to players in poker-style games) is known in poker style games.

A preferable card handling device for administering a video reel-type-style game is a hand-forming shuffler with integrated card recognition technology, from which playing cards are supplied, with a least a rank/count (and preferable also suit) of individual packs of cards are known before the cards are removed and delivered to player positions and/or the banker position. The card delivery system 102 is in communication with the controller 128 by wired or wireless communication methods. Communication between the various system components is not limited to electronic or electrical signals, but may include optical signals, audio signals, magnetic transmission or the like.

The shuffling devices work with various physical platforms. The shufflers may create a fully randomized set of cards that are removed one-at-a-time. Other shufflers separate cards into different compartments and then randomly deliver cards from the compartments. Other shufflers order the playing cards in compartments and then randomly select playing cards. Other randomization equipment (which do not actually shuffle cards) takes a set of playing cards are randomly ejects or randomly selects and removes playing cards from a set of playing cards.

The individual player position processors (not shown) are preferable graphics processors and not full content CPUs as a cost saving, space saving, and efficiency benefit. With the reduced capacity in the processor as compared to a CPU, there is actually reduced likelihood of tampering and fraudulent input.

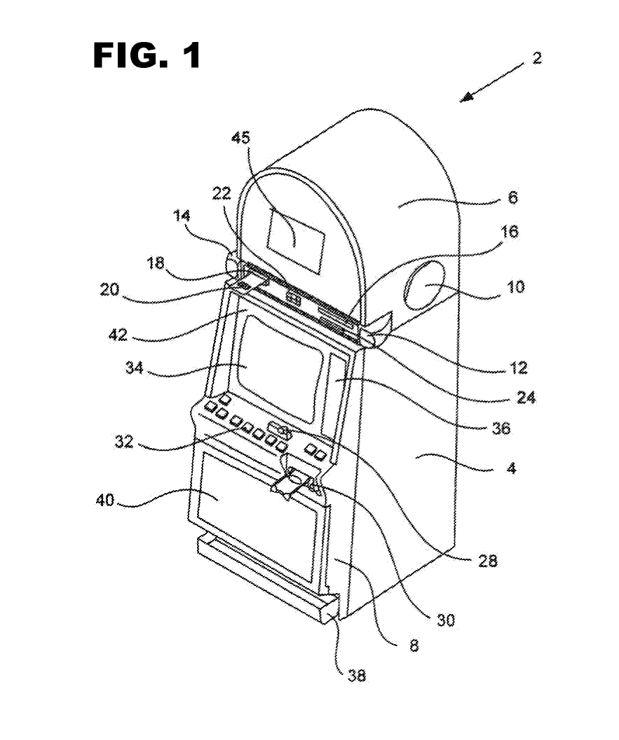

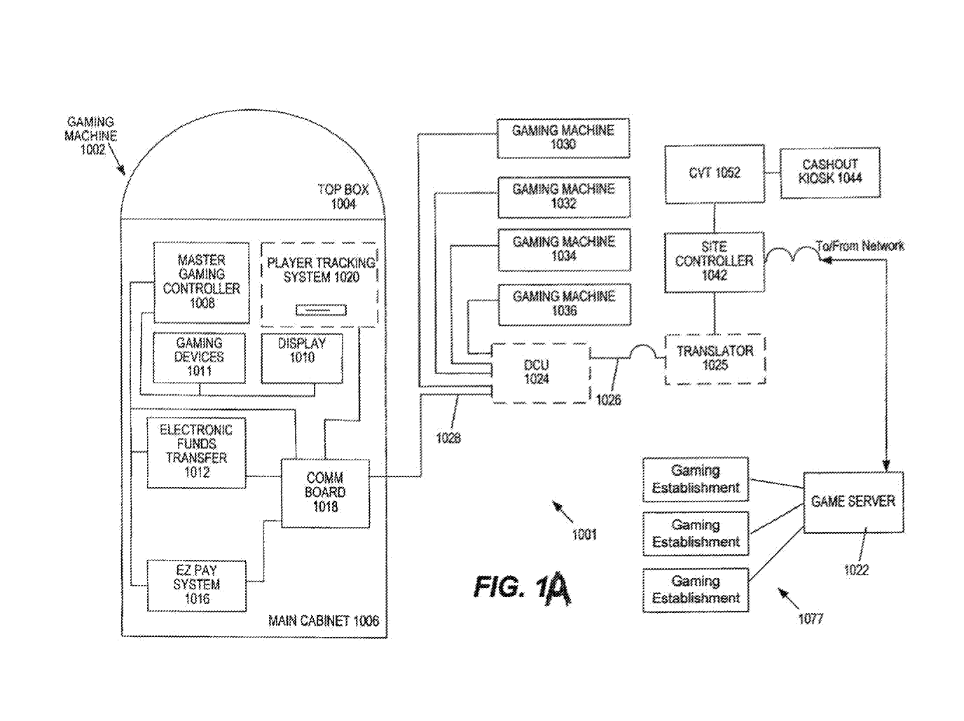

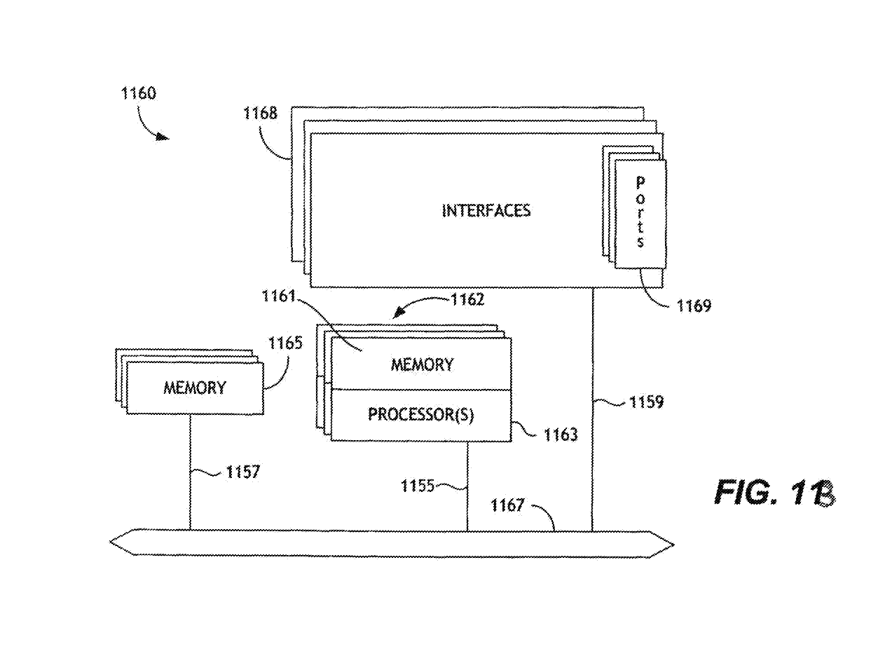

Turning next to FIG. 1, a video gaming machine 2 of the present invention is shown. Machine 2 includes a main cabinet 4, which generally surrounds the machine interior (not shown) and is viewable by users. The main cabinet includes a main door 8 on the front of the machine, which opens to provide access to the interior of the machine. Attached to the main door are player-input switches or buttons 32, a coin acceptor 28, and a bill validator 30, a coin tray 38, and a display area including a mechanical gaming system (or less preferably a separate electronic game) 40. There may be an overlay of touchscreen functionality on the separate electronic game 40 or some of the buttons 32 may be functional on the separate mechanical gaming system 40. That separate mechanical gaming system may be in a relatively vertical viewing position as shown or in a more horizontal (table like) display unit. Viewable through the main door is a video display monitor 34 and an information panel 36. The display monitor 34 will typically be a cathode ray tube, high resolution flat-panel LCD, LED, plasma screen or other conventional electronically controlled video monitor. The information panel 36 may be a back-lit, silk screened glass panel with lettering to indicate general game information including, for example, a game denomination (e.g. $0.25 or $1). The bill validator 30, player-input switches 32, video display monitor 34, and information panel are devices used to play a game on the game machine 2. The devices are controlled by circuitry (e.g. the master gaming controller) housed inside the main cabinet 4 of the machine 2.

Many different types of games, including mechanical slot games, video slot games, video poker, video black jack, video pachinko and lottery, may be provided with gaming machines of this invention. In particular, the gaming machine 2 may be operable to provide a play of many different instances of games of chance. The instances may be differentiated according to themes, sounds, graphics, type of game (e.g., slot game vs. card game), denomination, number of paylines, maximum jackpot, progressive or non-progressive, bonus games, etc. The gaming machine 2 may be operable to allow a player to select a game of chance to play from a plurality of instances available on the gaming machine. For example, the gaming machine may provide a menu with a list of the instances of games that are available for play on the gaming machine and a player may be able to select from the list a first instance of a game of chance that they wish to play.

The various instances of games available for play on the gaming machine 2 may be stored as game software on a mass storage device in the gaming machine or may be generated on a remote gaming device but then displayed on the gaming machine. The gaming machine 2 may executed game software, such as but not limited to video streaming software that allows the game to be displayed on the gaming machine. When an instance is stored on the gaming machine 2, it may be loaded from the mass storage device into a RAM for execution. In some cases, after a selection of an instance, the game software that allows the selected instance to be generated may be downloaded from a remote gaming device, such as another gaming machine.

The gaming machine 2 includes a top box 6, which sits on top of the main cabinet 4. The top box 6 houses a number of devices, which may be used to add features to a game being played on the gaming machine 2, including speakers 10, 12, 14, a ticket printer 18 which prints bar-coded tickets 20, a key pad 22 for entering player tracking information, a florescent display 16 for displaying player tracking information, a card reader 24 for entering a magnetic striped card containing player tracking information, and a video display screen 42. The ticket printer 18 may be used to print tickets for a cashless ticketing system. Further, the top box 6 may house different or additional devices than shown in the FIG. 1. For example, the top box may contain a bonus wheel or a back-lit silk screened panel which may be used to add bonus features to the game being played on the gaming machine. As another example, the top box may contain a display for a progressive jackpot offered on the gaming machine. During a game, these devices are controlled and powered, in part, by circuitry (e.g. a master gaming controller) housed within the main cabinet 4 of the machine 2.

Understand that gaming machine 2 is but one example from a wide range of gaming machine designs on which the present invention may be implemented. For example, not all suitable gaming machines have top boxes or player tracking features. Further, some gaming machines have only a single game display-mechanical or video, while others are designed for bar tables and have displays that face upwards. As another example, a game may be generated in on a host computer and may be displayed on a remote terminal or a remote gaming device. The remote gaming device may be connected to the host computer via a network of some type such as a local area network, a wide area network, an intranet or the Internet. The remote gaming device may be a portable gaming device such as but not limited to a cell phone, a personal digital assistant, and a wireless game player. Images rendered from 3-D gaming environments may be displayed on portable gaming devices that are used to play a game of chance. Further a gaming machine or server may include gaming logic for commanding a remote gaming device to render an image from a virtual camera in a 3-D gaming environments stored on the remote gaming device and to display the rendered image on a display located on the remote gaming device. Thus, those of skill in the art will understand that the present invention, as described below, can be deployed on most any gaming machine now available or hereafter developed.

Some preferred gaming machines are implemented with special features and/or additional circuitry that differentiates them from general-purpose computers (e.g., desktop PC's and laptops). Gaming machines are highly regulated to ensure fairness and, in many cases, gaming machines are operable to dispense monetary awards of multiple millions of dollars. Therefore, to satisfy security and regulatory requirements in a gaming environment, hardware and software architectures may be implemented in gaming machines that differ significantly from those of general-purpose computers. A description of gaming machines relative to general-purpose computing machines and some examples of the additional (or different) components and features found in gaming machines are described below.

At first glance, one might think that adapting PC technologies to the gaming industry would be a simple proposition because both PCs and gaming machines employ microprocessors that control a variety of devices. However, because of such reasons as 1) the regulatory requirements that are placed upon gaming machines, 2) the harsh environment in which gaming machines operate, 3) security requirements and 4) fault tolerance requirements, adapting PC technologies to a gaming machine can be quite difficult. Further, techniques and methods for solving a problem in the PC industry, such as device compatibility and connectivity issues, might not be adequate in the gaming environment. For instance, a fault or a weakness tolerated in a PC, such as security holes in software or frequent crashes, may not be tolerated in a gaming machine because in a gaming machine these faults can lead to a direct loss of funds from the gaming machine, such as stolen cash or loss of revenue when the gaming machine is not operating properly.

For the purposes of illustration, a few differences between PC systems and gaming systems will be described. A first difference between gaming machines and common PC based computers systems is that gaming machines are designed to be state-based systems. In a state-based system, the system stores and maintains its current state in a non-volatile memory, such that, in the event of a power failure or other malfunction the gaming machine will return to its current state when the power is restored. For instance, if a player was shown an award for a game of chance and, before the award could be provided to the player the power failed, the gaming machine, upon the restoration of power, would return to the state where the award is indicated. As anyone who has used a PC, knows, PCs are not state machines and a majority of data is usually lost when a malfunction occurs. This requirement affects the software and hardware design on a gaming machine.

A second important difference between gaming machines and common PC based computer systems is that for regulation purposes, the software on the gaming machine used to generate the game of chance and operate the gaming machine has been designed to be static and monolithic to prevent cheating by the operator of gaming machine. For instance, one solution that has been employed in the gaming industry to prevent cheating and satisfy regulatory requirements has been to manufacture a gaming machine that can use a proprietary processor running instructions to generate the game of chance from an EPROM or other form of non-volatile memory. The coding instructions on the EPROM are static (non-changeable) and must be approved by a gaming regulators in a particular jurisdiction and installed in the presence of a person representing the gaming jurisdiction. Any changes to any part of the software required to generate the game of chance, such as adding a new device driver used by the master gaming controller to operate a device during generation of the game of chance can require a new EPROM to be burnt, approved by the gaming jurisdiction and reinstalled on the gaming machine in the presence of a gaming regulator. Regardless of whether the EPROM solution is used, to gain approval in most gaming jurisdictions, a gaming machine must demonstrate sufficient safeguards that prevent an operator or player of a gaming machine from manipulating hardware and software in a manner that gives them an unfair and some cases an illegal advantage. The gaming machine should have a means to determine if the code it will execute is valid. If the code is not valid, the gaming machine must have a means to prevent the code from being executed. The code validation requirements in the gaming industry affect both hardware and software designs on gaming machines.

A third important difference between gaming machines and common PC based computer systems is the number and kinds of peripheral devices used on a gaming machine are not as great as on PC based computer systems. Traditionally, in the gaming industry, gaming machines have been relatively simple in the sense that the number of peripheral devices and the number of functions the gaming machine has been limited. Further, in operation, the functionality of gaming machines were relatively constant once the gaming machine was deployed, i.e., new peripherals devices and new gaming software were infrequently added to the gaming machine. This differs from a PC where users will go out and buy different combinations of devices and software from different manufacturers and connect them to a PC to suit their needs depending on a desired application. Therefore, the types of devices connected to a PC may vary greatly from user to user depending in their individual requirements and may vary significantly over time.

Although the variety of devices available for a PC may be greater than on a gaming machine, gaming machines still have unique device requirements that differ from a PC, such as device security requirements not usually addressed by PCs. For instance, monetary devices, such as coin dispensers, bill validators and ticket printers and computing devices that are used to govern the input and output of cash to a gaming machine have security requirements that are not typically addressed in PCs. Therefore, many PC techniques and methods developed to facilitate device connectivity and device compatibility do not address the emphasis placed on security in the gaming industry.

To address some of the issues described above, a number of hardware/software components and architectures are utilized in gaming machines that are not typically found in general purpose computing devices, such as PCs. These hardware/software components and architectures, as described below in more detail, include but are not limited to watchdog timers, voltage monitoring systems, state-based software architecture and supporting hardware, specialized communication interfaces, security monitoring and trusted memory.

A watchdog timer is normally used in gaming machines to provide a software failure detection mechanism. In a normally operating system, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits contain a loadable timeout counter register to allow the operating software to set the timeout interval within a certain range of time. A differentiating feature of the some preferred circuits is that the operating software cannot completely disable the function of the watchdog timer. In other words, the watchdog timer always functions from the time power is applied to the board.

Gaming computer platforms preferably use several power supply voltages to operate portions of the computer circuitry. These can be generated in a central power supply or locally on the computer board. If any of these voltages falls out of the tolerance limits of the circuitry they power, unpredictable operation of the computer may result. Though most modem general-purpose computers include voltage monitoring circuitry, these types of circuits only report voltage status to the operating software. Out of tolerance voltages can cause software malfunction, creating a potential uncontrolled condition in the gaming computer. Gaming machines typically have power supplies with tighter voltage margins than that required by the operating circuitry. In addition, the voltage monitoring circuitry implemented in gaming computers typically has two thresholds of control. The first threshold generates a software event that can be detected by the operating software and an error condition generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the computer.

The standard method of operation for slot machine game software is to use a state machine. Different functions of the game (bet, play, result, points in the graphical presentation, etc.) may be defined as a state. When a game moves from one state to another, critical data regarding the game software is stored in a custom non-volatile memory subsystem. This is critical to ensure the player's wager and credits are preserved and to minimize potential disputes in the event of a malfunction on the gaming machine.

In general, the gaming machine does not advance from a first state to a second state until critical information that allows the first state to be reconstructed is stored. This feature allows the game to recover operation to the current state of play in the event of a malfunction, loss of power, etc. that occurred just prior to the malfunction. After the state of the gaming machine is restored during the play of a game of chance, game play may resume and the game may be completed in a manner that is no different than if the malfunction had not occurred. Typically, battery backed RAM devices are used to preserve this critical data although other types of non-volatile memory devices may be employed. These memory devices are not used in typical general-purpose computers.

As described in the preceding paragraph, when a malfunction occurs during a game of chance, the gaming machine may be restored to a state in the game of chance just prior to when the malfunction occurred. The restored state may include metering information and graphical information that was displayed on the gaming machine in the state prior to the malfunction. For example, when the malfunction occurs during the play of a card game after the cards have been dealt, the gaming machine may be restored with the cards that were previously displayed as part of the card game. As another example, a bonus game may be triggered during the play of a game of chance where a player is required to make a number of selections on a video display screen. When a malfunction has occurred after the player has made one or more selections, the gaming machine may be restored to a state that shows the graphical presentation at the just prior to the malfunction including an indication of selections that have already been made by the player. In general, the gaming machine may be restored to any state in a plurality of states that occur in the game of chance that occurs while the game of chance is played or to states that occur between the play of a game of chance.

Game history information regarding previous games played such as an amount wagered, the outcome of the game and so forth may also be stored in a non-volatile memory device. The information stored in the non-volatile memory may be detailed enough to reconstruct a portion of the graphical presentation that was previously presented on the gaming machine and the state of the gaming machine (e.g., credits) at the time the game of chance was played. The game history information may be utilized in the event of a dispute. For example, a player may decide that in a previous game of chance that they did not receive credit for an award that they believed they won. The game history information may be used to reconstruct the state of the gaming machine prior, during and/or after the disputed game to demonstrate whether the player was correct or not in their assertion.

Another feature of gaming machines, such as gaming computers, is that they often contain unique interfaces, including serial interfaces, to connect to specific subsystems internal and external to the slot machine. The serial devices may have electrical interface requirements that differ from the “standard” EIA 232 serial interfaces provided by general-purpose computers. These interfaces may include EIA 485, EIA 422, Fiber Optic Serial, optically coupled serial interfaces, current loop style serial interfaces, etc. In addition, to conserve serial interfaces internally in the slot machine, serial devices may be connected in a shared, daisy-chain fashion where multiple peripheral devices are connected to a single serial channel.

The serial interfaces may be used to transmit information using communication protocols that are unique to the gaming industry. For example, the Netplex™ system of IGT is a proprietary communication protocol used for serial communication between gaming devices. As another example, SAS is a communication protocol used to transmit information, such as metering information, from a gaming machine to a remote device. Often SAS is used in conjunction with a player tracking system.

Gaming machines may alternatively be treated as peripheral devices to a casino communication controller and connected in a shared daisy chain fashion to a single serial interface. In both cases, the peripheral devices are preferably assigned device addresses. If so, the serial controller circuitry must implement a method to generate or detect unique device addresses. General-purpose computer serial ports are not able to do this.

Security monitoring circuits detect intrusion into a gaming machine by monitoring security switches attached to access doors in the slot machine cabinet. Preferably, access violations result in suspension of game play and can trigger additional security operations to preserve the current state of game play. These circuits also function when power is off by use of a battery backup. In power-off operation, these circuits continue to monitor the access doors of the slot machine. When power is restored, the gaming machine can determine whether any security violations occurred while power was off, e.g., via software for reading status registers. This can trigger event log entries and further data authentication operations by the slot machine software.

Trusted memory devices are preferably included in a gaming machine computer to ensure the authenticity of the software that may be stored on less secure memory subsystems, such as mass storage devices. Trusted memory devices and controlling circuitry are typically designed to not allow modification of the code and data stored in the memory device while the memory device is installed in the slot machine. The code and data stored in these devices may include authentication algorithms, random number generators, authentication keys, operating system kernels, etc. The purpose of these trusted memory devices is to provide gaming regulatory authorities a root trusted authority within the computing environment of the slot machine that can be tracked and verified as original. This may be accomplished via removal of the trusted memory device from the slot machine computer and verification of the secure memory device contents is a separate third party verification device. Once the trusted memory device is verified as authentic, and based on the approval of the verification algorithms contained in the trusted device, the gaming machine is allowed to verify the authenticity of additional code and data that may be located in the gaming computer assembly, such as code and data stored on hard disk drives. A few details related to trusted memory devices that may be used in the present invention are described in U.S. Pat. No. 6,685,567 titled “Process Verification,” which is incorporated herein in its entirety and for all purposes.

Mass storage devices used in a general purpose computer typically allow code and data to be read from and written to the mass storage device. In a gaming machine environment, modification of the gaming code stored on a mass storage device is strictly controlled and would only be allowed under specific maintenance type events with electronic and physical enablers required. Though this level of security could be provided by software, gaming computers that include mass storage devices preferably include hardware level mass storage data protection circuitry that operates at the circuit level to monitor attempts to modify data on the mass storage device and will generate both software and hardware error triggers should a data modification be attempted without the proper electronic and physical enablers being present.

Returning to the example of FIG. 1, when a user wishes to play the gaming machine 2, he or she inserts cash through the coin acceptor 28 or bill validator 30. Additionally, the bill validator may accept a printed ticket voucher which may be accepted by the bill validator 30 as an indicia of credit when a cashless ticketing system is used. At the start of the game, the player may enter playing tracking information using the card reader 24, the keypad 22, and the florescent display 16. Further, other game preferences of the player playing the game may be read from a card inserted into the card reader. During the game, the player views game information using the video display 34. Other game and prize information may also be displayed in the video display screen 42 located in the top box.

During the course of a game, a player may be required to make a number of decisions, which affect the outcome of the game. For example, a player may vary his or her wager on a particular game, select a prize for a particular game selected from a prize server, or make game decisions which affect the outcome of a particular game. The player may make these choices using the player-input switches 32, the video display screen 34 or using some other device which enables a player to input information into the gaming machine. In some embodiments, the player may be able to access various game services such as concierge services and entertainment content services using the video display screen 34 and one more input devices.

During certain game events, the gaming machine 2 may display visual and auditory effects that can be perceived by the player. These effects add to the excitement of a game, which makes a player more likely to continue playing. Auditory effects include various sounds that are projected by the speakers 10, 12, 14. Visual effects include flashing lights, strobing lights or other patterns displayed from lights on the gaming machine 2 or from lights within the separate mechanical (or electronic) separately, individually wagerable gaming system 40. After the player has completed a game, the player may receive game tokens from the coin tray 38 or the ticket 20 from the printer 18, which may be used for further games or to redeem a prize. Further, the player may receive a ticket 20 for food, merchandise, or games from the printer 18.

Another gaming network that may be used to implement some aspects of the invention is depicted in FIG. 1A. Gaming establishment 1001 could be any sort of gaming establishment, such as a casino, a card room, an airport, a store, etc. In this example, gaming network 1077 includes more than one gaming establishment, all of which are networked to game server 1022.

Here, gaming machine 1002, and the other gaming machines 1030, 1032, 1034, and 1036, include a main cabinet 1006 and a top box 1004. The main cabinet 1006 houses the main gaming elements and can also house peripheral systems, such as those that utilize dedicated gaming networks. The top box 1004 may also be used to house these peripheral systems.

The master gaming controller 1008 controls the game play on the gaming machine 1002 according to instructions and/or game data from game server 1022 or stored within gaming machine 1002 and receives or sends data to various input/output devices 1011 on the gaming machine 1002. In one embodiment, master gaming controller 1008 includes processor(s) and other apparatus of the gaming machines described above. The master gaming controller 1008 may also communicate with a display 1010.

A particular gaming entity may desire to provide network gaming services that provide some operational advantage. Thus, dedicated networks may connect gaming machines to host servers that track the performance of gaming machines under the control of the entity, such as for accounting management, electronic fund transfers (EFTs), cashless ticketing, such as EZPay™, marketing management, and data tracking, such as player tracking. Therefore, master gaming controller 1008 may also communicate with EFT system 1012, EZPay™ system, and player tracking system 1020. The systems of the gaming machine 1002 communicate the data onto the network 1022 via a communication board 1018.

It will be appreciated by those of skill in the art that embodiments of the present invention could be implemented on a network with more or fewer elements than are depicted in FIG. 1A. For example, player tracking system 1020 is not a necessary feature of some implementations of the present invention. However, player tracking programs may help to sustain a game player's interest in additional game play during a visit to a gaming establishment and may entice a player to visit a gaming establishment to partake in various gaming activities. Player tracking programs provide rewards to players that typically correspond to the player's level of patronage (e.g., to the player's playing frequency and/or total amount of game plays at a given casino). Player tracking rewards may be free meals, free lodging and/or free entertainment. Player tracking information may be combined with other information that is now readily obtainable by an SBG system.

Moreover, DCU 1024 and translator 1025 are not required for all gaming establishments 1001. However, due to the sensitive nature of much of the information on a gaming network (e.g., electronic fund transfers and player tracking data) the manufacturer of a host system usually employs a particular networking language having proprietary protocols. For instance, 10-20 different companies produce player tracking host systems where each host system may use different protocols. These proprietary protocols are usually considered highly confidential and not released publicly.

Further, gaming machines are made by many different manufacturers. The communication protocols on the gaming machine are typically hard-wired into the gaming machine and each gaming machine manufacturer may utilize a different proprietary communication protocol. A gaming machine manufacturer may also produce host systems, in which case their gaming machines are compatible with their own host systems. However, in a heterogeneous gaming environment, gaming machines from different manufacturers, each with its own communication protocol, may be connected to host systems from other manufacturers, each with another communication protocol. Therefore, communication compatibility issues regarding the protocols used by the gaming machines in the system and protocols used by the host systems must be considered.

A network device that links a gaming establishment with another gaming establishment and/or a central system will sometimes be referred to herein as a “site controller.” Here, site controller 1042 provides this function for gaming establishment 1001. Site controller 1042 is connected to a central system and/or other gaming establishments via one or more networks, which may be public or private networks. Among other things, site controller 1042 communicates with game server 1022 to obtain game data, such as ball drop data, bingo card data, etc.

In the present illustration, gaming machines 1002, 1030, 1032, 1034 and 1036 are connected to a dedicated gaming network 1022. In general, the DCU 1024 functions as an intermediary between the different gaming machines on the network 1022 and the site controller 1042. In general, the DCU 1024 receives data transmitted from the gaming machines and sends the data to the site controller 1042 over a transmission path 1026. In some instances, when the hardware interface used by the gaming machine is not compatible with site controller 1042, a translator 1025 may be used to convert serial data from the DCU 1024 to a format accepted by site controller 1042. The translator may provide this conversion service to a plurality of DCUs.

Further, in some dedicated gaming networks, the DCU 1024 can receive data transmitted from site controller 1042 for communication to the gaming machines on the gaming network. The received data may be, for example, communicated synchronously to the gaming machines on the gaming network.

Here, CVT 1052 provides cashless and cashout gaming services to the gaming machines in gaming establishment 1001. Broadly speaking, CVT 1052 authorizes and validates cashless gaming machine instruments (also referred to herein as “tickets” or “vouchers”), including but not limited to tickets for causing a gaming machine to display a game result and cash-out tickets. Moreover, CVT 1052 authorizes the exchange of a cashout ticket for cash. These processes will be described in detail below. In one example, when a player attempts to redeem a cash-out ticket for cash at cashout kiosk 1044, cash out kiosk 1044 reads validation data from the cashout ticket and transmits the validation data to CVT 1052 for validation. The tickets may be printed by gaming machines, by cashout kiosk 1044, by a stand-alone printer, by CVT 1052, etc. Some gaming establishments will not have a cashout kiosk 1044. Instead, a cashout ticket could be redeemed for cash by a cashier (e.g. of a convenience store), by a gaming machine or by a specially configured CVT.

FIG. 1B illustrates an example of a network device that may be configured for implementing some methods of the present invention. Network device 1160 includes a master central processing unit (CPU) 1162, interfaces 1168, and a bus 1167 (e.g., a PCI bus). Generally, interfaces 1168 include ports 1169 appropriate for communication with the appropriate media. In some embodiments, one or more of interfaces 1168 includes at least one independent processor and, in some instances, volatile RAM. The independent processors may be, for example, ASICs or any other appropriate processors. According to some such embodiments, these independent processors perform at least some of the functions of the logic described herein. In some embodiments, one or more of interfaces 1168 control such communications-intensive tasks as encryption, decryption, compression, decompression, packetization, media control and management. By providing separate processors for the communications-intensive tasks, interfaces 1168 allow the master microprocessor 1162 efficiently to perform other functions such as routing computations, network diagnostics, security functions, etc.

The interfaces 1168 are typically provided as interface cards (sometimes referred to as “linecards”). Generally, interfaces 1168 control the sending and receiving of data packets over the network and sometimes support other peripherals used with the network device 1160. Among the interfaces that may be provided are FC interfaces, Ethernet interfaces, frame relay interfaces, cable interfaces, DSL interfaces, token ring interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like.

When acting under the control of appropriate software or firmware, in some implementations of the invention CPU 1162 may be responsible for implementing specific functions associated with the functions of a desired network device. According to some embodiments, CPU 1162 accomplishes all these functions under the control of software including an operating system and any appropriate applications software.

CPU 1162 may include one or more processors 1163 such as a processor from the Motorola family of microprocessors or the MIPS family of microprocessors. In an alternative embodiment, processor 1163 is specially designed hardware for controlling the operations of network device 1160. In a specific embodiment, a memory 1161 (such as non-volatile RAM and/or ROM) also forms part of CPU 1162. However, there are many different ways in which memory could be coupled to the system. Memory block 1161 may be used for a variety of purposes such as, for example, caching and/or storing data, programming instructions, etc.

Regardless of network device's configuration, it may employ one or more memories or memory modules (such as, for example, memory block 1165) configured to store data, program instructions for the general-purpose network operations and/or other information relating to the functionality of the techniques described herein. The program instructions may control the operation of an operating system and/or one or more applications, for example.

Because such information and program instructions may be employed to implement the systems/methods described herein, the present invention relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media; and hardware devices that are specially configured to store and perform program instructions, such as read-only memory devices (ROM) and random access memory (RAM). The invention may also be embodied in a carrier wave traveling over an appropriate medium such as airwaves, optical lines, electric lines, etc. Examples of program instructions include both machine code, such as produced by a compiler, and files containing higher-level code that may be executed by the computer using an interpreter.

Although the system shown in FIG. 1B illustrates one specific network device of the present invention, it is by no means the only network device architecture on which the present invention can be implemented. For example, an architecture having a single processor that handles communications as well as routing computations, etc. is often used. Further, other types of interfaces and media could also be used with the network device. The communication path between interfaces may be bus based (as shown in FIG. 1B) or switch fabric based (such as a cross-bar).

There are many available variations and standard situations that can be addressed in the execution of the present direct game or side bet event in the present technology. The following discussion will attempt to address those variations, which may be mixed or excluded to implement a side bet wagering event with either blackjack or baccarat.

Aces are generally considered 1-value cards in baccarat. The unique event in baccarat can therefore be either a same-suited Ace-3, or a same-suited Ace-Queen for the 100% payout. Both of those point counts would ordinarily require an additional card, so game play would not be altered in either selection of the unique 100% jackpot event (or 5%, 10%, 20%, 25% etc. jackpot events). Pairs are automatic losses on the side bet for baccarat. In blackjack, players may elect to split pairs, but to engage the side bet event, an additional (preferably equal or less) side bet wager must be placed on a second hand for the second hand to be in play. Otherwise, only the first hand (player's furthest right set of cards).

Ace ranks in blackjack can be more complicated, but can be easily regulated. For example, aces should usually be maintained as an 11-value card for the side bet event. For purposes of the jackpot unique events, however, the rank may be considered as a 1-value card for the Ace-3 combination in first two cards, and may be considered as a 1-value card in combination with a 3 (unsuited), any 4, any 5, (possibly) any 6 (treating the combination as a soft 17), but should be considered an 11-value card with any 7, 8, 9 or 10-value card (not sacrificing a blackjack for the side bet). House procedures may vary this, but the above is recommended.

The occurrence of certain events (with respect to the side bet) has already been addressed, but there are acceptable variations among them. By way of non-limiting examples, so as to minimize a feeling of “unfair” results with the side bet wager, certain natural hands can be specifically addressed. A hard 17 with a 10-value card (as opposed to an 8-9 combination) may be considered a push or a loss. A hard 18 with a 10-value card (as opposed to a 9-9 combination) may be considered a push or a loss. All hard 19's (with a 10-value card) may be considered a loss or a push. All hard 20's (with two 10-value cards) may be considered a loss or a push. All 10-value cards may be considered as a single rank (a rank between 9 and Ace), so that with an initial two cards of 9 and King, the third card of a Jack would not be an intermediate card, nor would a Queen or 10. This may be varied, with the 10 itself being considered as distinct from the Jack, Queen or King in determining intermediate ranks within the spread. All pairs can be considered in the first two cards as losses, unless the player elects to split them and place a second side bet wager for the second hand. If the pairs are aces, however, the side bet is lost as most casino blackjack events allow only a single hit at each hand position when aces are split. This consideration of events complies with standard blackjack practice to minimize alteration of game play.

Players may elect to “convert” an Ace in combination with a ten value card to a 1-value Ace. To do so, the player may be required to double the amount of the side bet, and in that circumstance, it is likely that all 10-value cards would be equal. The “conversion” would also have to be permanent, such that the blackjack is lost. The player may (as with a double down) be allowed only a single hit if this is done, or may be allowed only two hits.

Combinations and variations and adjustments of these event outcome controlling circumstances may be imposed upon the side bet wagering event.

The present technology offers significant technical advantages over other progressive gaming systems, particularly with respect to integrating progressive games on both physical gaming tables (e.g., with physical playing cards), electronic gaming tables, electronic gaming machines, and even internet gaming). One problem that has been encountered in the art, in addition to the inability to provide a large progressive jackpot potential as described herein for event outcomes resolved with three playing cards without altering fundamental game play, and enabling resolution of wagers immediately upon provision of the initial three cards, is the ability to fairly link multiple blackjack or baccarat games in a progressive event without offering advantages to one format versus another format.

For example, if the present progressive or other progressive events were provided with different numbers of decks, if critical cards were allowed to be exhausted differentially in different venues or formats, if different critical cards were provided in different percentages at different formats or venues, and the like, players would perceive these differences and tend to shy away from disadvantageous venues or not engage in the progressive event at all.

According to the following disclosure, not only may different venues be associated with a single jackpot, but different formats and games may be linked without any advantage to any class or type of player.

The present technology allows for the linking of any gaming technology in which, either to a player only, a dealer only or a combination of dealer and player (e.g., including banker), three initial playing cards are dealt, and two of the cards are in a distinct order of dealing or at a distinct location. That is, a game such as 3-card Poker™ events where all three cards are dealt at the same time in a single packet would be excluded, but a 3-card poker event where a first two cards are dealt and then a distinct third card is dealt, could be used. Numerous such games have been described herein where that occurs, and other games are and can be made available.

In dealing any linked formats and games and venues and machines, all deliveries of these three initial playing cards are dealt with two of the cards in a distinct order of dealing or at a distinct location and the third card delivered so as to be physically, spacially and/or time distinct from the first two cards. The cards should be dealt, and as described herein, can be dealt, from statistically equivalent sources.

Assuming an eight-deck source of playing cards, all electronic dealings (internet, electronic gaming tables and electronic gaming machines) may be dealt from virtual complete randomized sets of virtual playing cards at the beginning of each round of play. The eight decks would also have equal distributions of the critical cards at the beginning of each round of play, as with three of each of Ace of Spades, King of Spades and Queen of spades available at the initial round of play. These eight-deck sets would be made hole at the beginning of each deal. In a physical playing card table game, if identical equality of probabilities and occurrences were desired, a continuous shuffler would be used, wherein all playing cards used in previous hands are added to the continuous shuffler before each round of play. In this manner, all hands of play in the physical gaming card tables would have the same numbers and types of cards in random availability at the beginning of each hand as the electronic virtual card-providing systems would have. Players would appreciate the fact that all probabilities at all venues would be equivalent. This would greatly enhance the growth of jackpots if all formats and venues could be linked into a single progressive jackpot, as many more progressive side bet wagers from multiple sources would be adding to the size of the progressive jackpot.

It is also possible and desirable to use batch shufflers or pre-randomized shoes in the linked system, with players being informed of the statistically lower or higher richness of critical cards in play. They may then decide whether or not to play the progressive jackpot event in one venue or another.

It is also complex, yet desirable, to link gaming formats and systems with different wagering limits into a single progressive jackpot. This may work where an exact, absolute amount, minimum progressive side bet is required (typically $1.00), but that format does not work where, for example, a player is at a 100-line blackjack video machine playing each hand for $0.01, $0.05, $0.10, $0.25 or even $1.00. Players would not be willing to enter the progressive jackpot (especially with 100 hands) for 100 times the amount of their underlying wager. Yet, because of the greatly increased volume of wagers at the penny machines (and other lower cost machines with large numbers of paylines), these are attractive markets and participation in the progressive jackpots are desirable. One mechanism for enabling linking with vastly different underlying game minimums and side bet wagering is, for the first time, to directly and proportionally link all side bets from multiple sources into a single progressive jackpot. For example, in the electronic games, the range of the side bet may be selected from within a range of $0.01 to $1.00 by control of the player. The side bet wager may also be tied (in equal lesser or greater amount to the actual wagered amount. The player, especially in multi-line play, may also limit the number of hands on which the side bet will be placed. For example, in a 50-play blackjack event, the player may elect to have the side bet wager on only the main hand, the first 10 hands, the last 25 hands, etc., by inputting directions and commands as to numbers and positions of hands on which side bet may be placed. The progressive jackpot winning outcomes are awarded in a proportional basis to the size of the side bet entered, up to a standard wager, for example the $1.00 (or 1 significant wagering unit in another currency, such as a Euro, a Pound, etc.). A wager at 1% of the significant wagering unit would be awarded 1% of the value of the progressive jackpot award if the significant wagering unit had been wagered on a winning outcome. Thus, if a $1.00 progressive wager would win $1,000,000 with specially bonus-marked A-K-Q of spades, a $0.01 wager would win $10,000.00. Wagering more than a standard one significant wagering unit would not increase progressive awards, but would increase awards against odds. Thus, a $0.02 wager at a penny machine would win up to 2% of the maximum progressive jackpot, but would still be paid 1:1 odds for high SPREAD hands with a filling WEDGE card.

By enabling proportional progressive jackpot awards from different formats, venues, devices and the like, a fair distribution of the jackpot is enabled while requiring a fair and proportionate contribution to the jackpot from each player position.

This system would work by having each individual wagering location (e.g., table, electronic gaming machine, array of machines, multiplayer platform, internet site) identify to a central progressive jackpot accounting server an amount of the side bet wager placed. The central progressive jackpot accounting server will contribute a same defined portion of the progressive side bet wager (e.g., 20%, 50%, 17% or the like) independent of the size of the side bet. When small side bets (e.g., $0.01) are being wagered, the accounting function may incrementally and sequentially contribute amounts to the progressive jackpot fund (e.g., where a 25% contribution is to be made, either a first, second, third or fourth penny wager may be fully contributed to the progressive jackpot fund and the remainder retained by the accounting function as house profit). This system further enables small wager players to play multi-line games and participate in potential progressive jackpot awards.

While this invention is described in terms of preferred embodiments, there are alterations, permutations, and equivalents that fall within the scope of the invention. It should also be noted that there are many alternative ways of implementing the present invention. It is therefore intended that the invention not be limited to the preferred embodiments described herein, but instead that the invention should be interpreted as including all such alterations, permutations, and equivalents as fall within the true spirit and scope of the present invention.

What is claimed:

1. A method of performing a side bet wagering event during a physical playing card wagering event at a gaming table comprising:
a) a player position providing a progressive side bet wager to be determined by physical playing cards provided to at least two positions distinguished by at least one of position and time;
b) providing two random physical playing cards to a first hand position defined as a SPREAD position, and providing one random physical playing card to a second hand position defined as a WEDGE card position, the SPREAD position and the WEDGE card position distinguished by at least one of physical position of delivery and time of delivery of random cards;
c) determining the spread between the two random playing cards in the SPREAD position on which the side bet wager has been placed;
d) determining whether the side bet has been lost because of a spread of zero between the two random playing cards in the SPREAD position on which the side bet wager has been placed;
f) upon determining that there is a spread in excess of zero between the two random physical playing cards in the SPREAD position on which the side bet wager has been placed, using the one random physical playing card in the WEDGE position as a third physical playing card to determine if the third random physical playing card is within or not within the spread; and
h) resolving the side bet wager against a paytable which identifies odds at least dependent on the spread determined in e) based upon the determination whether the third random physical playing card is within or not within the spread;
wherein at least a portion of the side bet wager, but less than all of the side bet wager is contributed to a progressive jackpot, the amount of which progressive jackpot is stored, incremented and decremented in an accounting processor, decrementing being based in-part upon resolution of the side bet for outcomes where percentages of a total value amount in the progressive jackpot are awarded for defined random event outcomes when the third random physical playing card is within the spread, and the processor sends a signal to a display screen available for view at the player position indicating status of the jackpot amount.

2. The method of claim 1 wherein an original set of multiple decks of physical playing cards is used as a source for physical playing cards in b).

3. The method of claim 2 wherein the physical decks of playing cards comprise six standard decks of playing cards in which at least some of each of three cards in the six decks having sequential ranks and same suits have a marking on them identifying them as progressive bonus jackpot cards.

4. The method of claim 3 wherein a percentage of the progressive jackpot is awarded to a player position that has placed the progressive side bet wager when the presence of the three cards having sequential ranks and same suits appears as a highest and lowest rank of the three sequential cards in the SPREAD position and an intermediate rank of the three sequential cards, and either one, two or three of the three sequential cards have the marking on them identifying them as progressive bonus jackpot cards.

5. The method of claim 3 wherein only between 1 and 5 of each card of rank and suit within the cards of sequential rank and same suits within the six standard decks of playing cards have the marking on them identifying them as progressive bonus jackpot cards.

6. The method of claim 3 wherein only between 1 and 5 of each card of rank and suit within the cards of sequential rank and same suits within the six standard decks of playing cards have the marking on them identifying them as progressive bonus jackpot cards.

7. The method of claim 4 wherein the SPREAD hand is determined by a player initial two-card hand in a game of blackjack and the WEDGE hand is determined by a physical dealer up-card in the game of blackjack.

8. The method of claim 4 wherein the SPREAD hand is determined by a player initial two-card hand in a game of baccarat and the WEDGE hand is determined by a single random physical card at a banker position in the game of baccarat.

9. The method of claim 4 wherein the SPREAD hand is determined by a player hand in a game of baccarat and the WEDGE hand is determined by a single physical card from among two physical cards at a banker position in the game of baccarat.

10. The method of claim 4 wherein the SPREAD hand is determined by a banker initial two-card hand in a game of baccarat and the WEDGE hand is determined by a single random physical card at a player position in the game of baccarat.

11. The method of claim 1 wherein the accounting processor is also in communication with an electronic wagering system comprising a separate processor, display system, and player input controls, the electronic wagering system including a progressive side bet input as part of the player input controls, and the progressive jackpot is incremented and decremented by a method performed on the electronic wagering system by:
h) a second player position at the electronic wagering system providing a progressive side bet wager to be determined by virtual playing cards provided to at least two positions distinguished by at least one of position and time on the display system;
i) providing two random virtual playing cards to a second first hand position on the display system defined as a SPREAD position, and providing one random virtual playing card to a second hand position defined as a WEDGE card position, the second SPREAD position and the second WEDGE card position distinguished by at least one of physical position of delivery and time of delivery of random cards on the display system;
j) determining the spread between the two random virtual playing cards in the second SPREAD position on which the side bet wager has been placed;
k) determining whether the side bet has been lost because of a spread of zero between the two random virtual playing cards in the second SPREAD position on which the side bet wager has been placed;
l) upon determining that there is a spread in excess of zero between the two random virtual playing cards in the second SPREAD position on which the side bet wager has been placed, using the one random virtual playing card in the second WEDGE position as a third virtual playing card to determine if the third random virtual playing card is within or not within the spread; and
m) resolving the side bet wager against a paytable which identifies odds at least dependent on the spread determined in 1) based upon the determination whether the third random physical playing card is within or not within the spread;
wherein at least a portion of the side bet wager, but less than all of the side bet wager is contributed to the progressive jackpot, the amount of which progressive jackpot is stored, incremented and decremented in the accounting processor, decrementing being based in-part upon resolution of the side bet for outcomes where percentages of a total value amount in the progressive jackpot are awarded for defined random event outcomes when the third random virtual playing card is within the spread, and the processor sends a signal to a display screen available for view at the second player position on the electronic wagering system indicating status of the jackpot amount.

12. The method of claim 11 wherein the electronic gaming system comprises a system selected from the group consisting of internet wagering systems, networked video gaming systems, and playing-card-less electronic gaming tables.

13. The method of claim 11 wherein the electronic gaming system comprises networked video gaming systems.

14. The method of claim 13 wherein the electronic video gaming system accepts a progressive side bet in an amount that is less than a minimally allowable progressive side bet wager at the physical playing card wagering event at the gaming table, and a percentage of the progressive jackpot is awarded at the electronic video gaming system in an absolute value amount proportionate to the progressive side bet amount at the electronic video gaming system as compared to the amount that is the minimally allowable progressive side bet wager at the physical playing card wagering event at the gaming table.

15. The method of claim 11 wherein the physical playing cards provided at the gaming table are provided from a continuous shuffler, and after each round of play of the physical playing card wagering event, physical playing card previously used are returned to the continuous shuffler.

16. The method of claim 13 wherein the physical playing cards provided at the gaming table are provided from a continuous shuffler, and after each round of play of the physical playing card wagering event, physical playing card previously used are returned to the continuous shuffler.

17. A method of performing a side bet wagering event during a blackjack wagering event comprising:
a) a player position providing a side bet wager to be determined by playing cards provided to at least one of the dealer hand position and the player hand position;
b) providing two random playing cards to a dealer hand position with only one card in a face-up position, and providing two random playing cards to a player hand position in a face-up position;
c) determining the spread between the two random playing cards in the player hand position on which the side bet wager has been placed;
d) determining whether the side bet has been lost because of a spread of zero between the two random playing cards in the player hand position on which the side bet wager has been placed;
e) upon determining that there is a spread in excess of zero between the two random playing cards in the player hand position on which the side bet wager has been placed, and using as a third playing card, the only one dealer hand position face up card;
f) determining if the third playing card is within or not within the spread; and
g) resolving the side bet wager against a paytable which identifies odds at least dependent on the spread determined in e) based upon the determination whether the third playing card is within or not within the spread;
wherein at least a portion of the side bet wager, but less than all of the side bet wager is contributed to a progressive jackpot, the amount of which is stored, incremented and decremented in a processor, decrementing being based in-part upon resolution of the side bet for outcomes where percentages of a total in the progressive jackpot are awarded for defined random event outcomes when the third playing card is within the spread, and the processor sends a signal to a display screen available for view at the player position indicating status of the jackpot amount.

18. The method of claim 16 wherein the method is performed on a gaming table and the side bet wager are provided through an electronic wagering input device on the gaming table, and the input device communicates location of a player position at which a side bet wager has been placed and an amount of the side bet wager to the processor.

19. The method of claim 17 wherein the processor transfers a portion of the side bet wager into a progressive jackpot account monitored by the processor and the processor causes a display to visually indicate an available balance in the jackpot.

20. The method of claim 18 when a highest payout from the progressive jackpot comprises the third card being a suited rank card within a spread created by two of the same suited playing cards that provide a spread of one at the position at which a side bet wager has been placed and an amount of the side bet wager to a processor.

21. The method of claim 18 when a highest payout from the progressive jackpot comprises the third card being a suited rank card within a spread created by two of the same suited playing cards that provide a spread of one at the position at which a side bet wager has been placed and an amount of the side bet wager to a processor and at least one of the three cards has a bonus indicator necessary for the side bet to win 100% of the jackpot.

22. The method of claim 19 when a highest payout from the progressive jackpot comprises the third card being a suited rank card within a spread created by two of the same suited playing cards that provide a spread of one at the position at which a side bet wager has been placed and an amount of the side bet wager to a processor and at least one of the three cards has a bonus indicator necessary for the side bet to win 100% of the jackpot.

23. The method of claim 17 wherein the playing cards are physical playing cards provided from an electromechanical device providing one or more random cards for manual delivery to the player hand position and the dealer hand position.

24. A method of performing a side bet wagering event during a blackjack or baccarat wagering event comprising:
a) a player position providing a side bet wager to be determined by exactly playing cards provided to at least one of the dealer hand position in blackjack or banker hand position in baccarat and the player hand position;
b) providing two random playing cards to a dealer or banker hand position, and providing two random playing cards to a player hand position;
c) determining the spread between the two random playing cards in the hand on which the side bet wager has been placed;
d) determining whether the side bet has been lost because of a spread of zero between the two random playing cards in the hand on which the side bet wager has been placed;
e) upon determining that there is a spread in excess of zero between the two random playing cards in a hand on which the side bet wager has been placed, and using one random playing card from a hand on which the side bet wager has not been placed as a third card, determining if the third playing card is within or not within the spread; and
f) resolving the side bet wager against a paytable which identifies odds at least dependent on the spread determined in e) based upon the determination whether the third playing card is within or not within the spread;
wherein at least a portion of the side bet wager, but less than all of the side bet wager is contributed to a progressive jackpot, the amount of which is stored, incremented and decremented in a processor, decrementing being based in-part upon resolution of the side bet for outcomes where percentages of a total in the progressive jackpot are awarded for defined random event outcomes when the third playing card is within the spread, and the processor sends a signal to a display screen available for view at the player position indicating status of the jackpot amount.

25. The method of claim 24 wherein a single combination of same-suited and ranked random playing cards forming a spread of one is used to identify events in which specific percentages of the progressive jackpot may be awarded, and a single random playing is used as the third card to identify events in which specific percentages of the progressive jackpot may be awarded.

26. The method of claim 24 wherein the random playing cards are provided from multiple sets of playing cards, the multiple sets having multiple ones of each of the playing cards used in the combination of suited and ranked cards forming a spread of one and the third card which is intermediate the spread are used to identify events in which specific percentages of the progressive jackpot may be awarded, and fewer than all of each one of the multiple sets have progressive jackpot bonus markings thereo.

27. The method of claim 24 wherein at least some, but less than all, of the playing cards used in the combination of suited and ranked cards forming a spread of one is used to identify events in which specific percentages of the progressive jackpot may be awarded have markings or color on them indicating that percentages of the jackpot may be won.

28. A method of performing a side bet wagering event during a baccarat wagering event comprising:
a) a player position providing a side bet wager to be determined by playing cards provided to at least one of the banker hand position and the player hand position;
b) providing two random playing cards to a banker hand position, and providing two random playing cards to a player hand position;
c) determining the spread between the two random playing cards in the player position hand or the banker hand position on which the side bet wager has been placed;
d) determining whether the side bet has been lost because of a spread of zero between the two random playing cards in the hand on which the side bet wager has been placed;
e) upon determining that there is a spread in excess of zero between the two random playing cards in the player position hand or banker hand position on which the side bet wager has been placed, both banker position hand playing cards or player hand position playing cards, respectively, are used as a third or fourth random playing card,
f) determining if the third or fourth random playing card is within or not within the spread; and
g) resolving the side bet wager against a paytable which identifies odds at least dependent on the spread determined in e) based upon the determination whether the third or fourth playing card is within or not within the spread;
wherein at least a portion of the side bet wager, but less than all of the side bet wager is contributed to a progressive jackpot, the amount of which is stored, incremented and decremented in a processor, and the processor sends a signal to a display screen available for view at the player position.

29. The method of claim 26 wherein the percentages of the jackpot are awarded on the side bet wager when there is a spread of two, the spread of two is defined by specific ranks and suits of the random cards defining the spread of two, the third and fourth cards exactly fill the spread of two with two random cards each having the same suit as the random cards determining the spread and dissimilar ranks from the two random cards defining the spread.

30. A method of performing a side bet wagering event during a virtual playing card wagering event at an electronic wagering system comprising a housing, player input controls on the housing in communication with an accounting processor, and a video display in communication with the accounting processor, the processor being in communication with multiple individual wagering systems, the method comprising:
a) a player position at the electronic wagering system, the player input controls entering a progressive side bet wager that is received by the accounting processor, an outcome on the progressive side bet wager to be determined by virtual playing cards provided to at least two positions on the display system distinguished by at least one of position and time;
b) a gaming processor providing two random virtual playing cards to a first hand position defined as a SPREAD position, and providing one random virtual playing card to a second hand position defined as a WEDGE card position, the SPREAD position and the WEDGE card position distinguished by at least one of physical position of delivery and time of delivery of random cards to the video display;
c) the gaming processor determining the spread between the two random virtual playing cards in the SPREAD position on which the side bet wager has been placed;
d) the gaming determining whether the side bet has been lost because of a spread of zero between the two random playing cards in the SPREAD position on which the side bet wager has been placed;
f) upon the gaming determining that there is a spread in excess of zero between the two random virtual playing cards in the SPREAD position on which the side bet wager has been placed, using the one random virtual playing card in the WEDGE position as a third virtual playing card to determine if the third random virtual playing card is within or not within the spread; and
i) the accounting processor resolving the side bet wager against a paytable which identifies odds at least dependent on the spread determined in e) based upon the determination whether the third random virtual playing card is within or not within the spread;
wherein at least a portion of the side bet wager, but less than all of the side bet wager is contributed to a progressive jackpot monitored by the accounting processor, the amount of which progressive jackpot is stored, incremented and decremented in the accounting processor, decrementing being based in-part upon resolution of the side bet for outcomes where percentages of a total value amount in the progressive jackpot are awarded for defined random event outcomes when the third random virtual playing card is within the spread, and the accounting processor sends a signal to the display system available for view at the player position indicating status of the jackpot amount.

31. The method of claim 30 wherein an original virtual set of multiple decks of physical playing cards is used as a source for the virtual playing cards in b).

32. The method of claim 31 wherein the virtual decks of playing cards comprise at least six virtual standard decks of playing cards in which at least some of each of three virtual cards in the six decks have sequential ranks and same suits and have a marking on them identifying them as progressive bonus jackpot cards.

33. The method of claim 31 wherein a percentage of the progressive jackpot is awarded to a player position that has placed the progressive side bet wager when the presence of the three virtual cards having sequential ranks and same suits appears as a highest and lowest rank of the three sequential virtual cards in the SPREAD position and an intermediate rank of the three sequential virtual cards, and either one, two or three of the three sequential virtual cards have the marking on them identifying them as progressive bonus jackpot cards.
